(19) United States
(12) Patent Application Publication
(10) Pub. No.: US 2014/0171379 A1
(43) Pub. Date: Jun. 19, 2014

(54) LIGNIN COMPOSITIONS, METHODS OF PRODUCING THE COMPOSITIONS, METHODS OF USING LIGNIN COMPOSITIONS, AND PRODUCTS PRODUCED THEREBY

(71) Applicants: Robert Jansen, Collinsville, IL (US); Aharon Eyal, Jerusaiem, IL (US); Noa Lapidot, Mevaseret Zion, IL (US); Bassem Hallac, Jerusalem, IL (US); Ziv-Vladimir Belman, Kiryat-yam, IL (US); Shmuel Kenig, Haifa, IL (US)

(72) Inventors: Robert Jansen, Collinsville, IL (US); Aharon Eyal, Jerusaiem, IL (US); Noa Lapidot, Mevaseret Zion, IL (US); Bassem Hallac, Jerusalem, IL (US); Ziv-Vladimir Belman, Kiryat-yam, IL (US); Shmuel Kenig, Haifa, IL (US)

(21) Appl. No.: 14/009,863

(22) PCT Filed: Apr. 4, 2012
(86) PCT No.: PCT/US12/32228

§ 371 Date: Feb. 28, 2014

Related U.S. Application Data
(60) Provisional application No. 61/473,134, filed on Apr. 7, 2011.
(60) Provisional application No. 61/483,663, filed on May 7, 2011.
(60) Provisional application No. 61/491,243, filed on May 30, 2011.
(60) Provisional application No. 61/626,307, filed on Sep. 22, 2011.
(60) Provisional application No. 61/552,402, filed on Oct. 27, 2011.
(60) Provisional application No. 61/559,529, filed on Nov. 14, 2011.
(60) Provisional application No. 61/602,514, filed on Feb. 23, 2012.
(60) Provisional application No. 61/620,195, filed on Apr. 4, 2012.
(60) Provisional application No. 61/620,186, filed on Apr. 4, 2012.

(30) Foreign Application Priority Data
Jun. 1, 2011 (IL) PCT/IL2011/000424

(51) Int. Cl. C08K 13/02; C07G 1/00

(52) U.S. Cl. CPC C08K 13/02; C07G 1/00
USPC 514/22; 502/404; 252/601; 530/500; 524/27; 523/447; 264/8

(57) ABSTRACT

Lignin compositions, lignin particles, products containing them, viscous paste containing lignin, lignin formulations, spinning methods, fibers, products produced from the fibers, methods to produce processed products from lignin, methods to produce downstream products, manufacturing processes and related products are described.

### RELATED APPLICATIONS

In accord with the provisions of 35 U.S.C. §119(e) and §363, this application claims the benefit of:

U.S. 61/473,134 filed on Apr. 7, 2011 by Aharon EYAL et al. and entitled “Lignocellulose Conversion Processes and Products”;

U.S. 61/483,663 filed on May 7, 2011 by Aharon EYAL et al. and entitled “Lignocellulose Conversion Processes and Products”;

U.S. 61/491,243 filed on May 30, 2011 by Aharon EYAL et al. and entitled “Methods and Systems for Processing Lignocellulosic Materials”;

U.S. 61/626,307 filed on Sep. 22, 2011 by Aharon EYAL et al. and entitled “Lignin and Lignin Particles”;

U.S. 61/552,402 filed on Oct. 27, 2011 by Aharon EYAL et al. and entitled “Lignin Compositions, Methods of Producing the Compositions, Methods of Using Lignin, and Products Produced Thereby”;

U.S. 61/559,529 filed on Nov. 14, 2011 by Aharon EYAL et al. and entitled “Lignin Compositions, Methods of Producing the Compositions, Methods of Using Lignin, and Products Produced Thereby”;

U.S. 61/602,514 filed on Feb. 23, 2012 by Aharon EYAL et al. and entitled “Lignin Compositions, Methods Of Producing The Compositions, Methods Of Using Lignin Compositions, and Products Produced Thereby”;

U.S. 61/620,186 filed on Apr. 4, 2012 by Aharon EYAL et al. and entitled “Lignin Compositions, Methods of Producing the Compositions, Methods Of Using Lignin Compositions, and Products Produced Thereby”; and

U.S. 61/620,195 filed on Apr. 4, 2012 by Aharon EYAL et al. and entitled “Lignin Compositions, Methods of Producing the Compositions, Methods Of Using Lignin Compositions, and Products Produced Thereby”; each of which is fully incorporated herein by reference.

In addition, in accord with the provisions of 35 U.S.C. §119(a) and/or §365(b), this application claims priority from:

PCT/IL 2011/000424 filed on Jun. 1, 2011 by Robert JANSEN et al. and entitled “Lignin Compositions, Systems and Methods for Processing Lignin and/or HCl”; each of which is fully incorporated herein by reference.

### FIELD OF THE INVENTION

This invention relates to lignin, lignin particles, lignin compositions, methods to produce and/or use them and products produced therefrom.

### BACKGROUND OF THE INVENTION

Plant derived lignocellulosic materials or “woody materials” contain cellulose, hemicellulose and lignin as their main components. They may also contain mineral salts (ashes) and lipophilic organic compounds, such as tall oils. The type and content of these non-carbohydrate materials can vary depending upon the specific woody material.

Lignocellulosic materials typically contain 65-80% cellulose and hemicelluloses on a dry matter basis. Cellulose and hemicellulose are polysaccharides which can release carbohydrates suitable for fermentation and/or chemical conversion to products of interest if they are hydrolyzed. Lignin is typically resistant to acid hydrolysis.

Acid hydrolysis of a lignocellulosic substrate using strong acids (e.g. sulfuric acid or hydrochloric acid) forms a liquid hydrolyzate containing soluble carbohydrates, contaminants soluble in aqueous acid solution and the acid. Typically, the acid is diluted to some degree by release of water from the substrate.

Since lignin present in the substrate does not hydrolyze and stays essentially insoluble, the acid hydrolysis also produces lignin dispersed in, or wetted by, an aqueous solution of acid (e.g. HCl).

A primary industrial use of lignin is currently combustion as fuel. It is estimated that approximately 70 million tons of lignin are burned each year. Much of this material is presently available as Kraft black liquor from the paper industry.

Lignin is more energy rich than wood on a dry matter basis.

### SUMMARY OF THE INVENTION

A broad aspect of the invention relates to increasing the value of lignin. In some embodiments, the lignin is a byproduct of hydrolysis of lignocellulosic or woody materials. This hydrolysis may be, for example, with acids, reactive fluids or enzymes.

One aspect of some embodiments of the invention relates to lignin compositions. According to various exemplary embodiments of the invention the compositions are provided as solids and/or gels and/or solutions and/or suspensions and/or a viscous paste. Optionally, solid lignin compositions are provided as fibers. In some exemplary embodiments of the invention, the lignin composition is incorporated into a product comprising additional ingredients.

Another aspect of some embodiments of the invention relates to solid lignin particles suspended in a solvent which also contains dissolved lignin as a solute.

Another aspect of some embodiments of the invention relates to positively charged particles suspended in a solvent which also contains dissolved lignin as a solute. Optionally, the particles contain metal oxides.

Another aspect of some embodiments of the invention relates to spinning of lignin to form fibers. According to various exemplary embodiments of the invention the spinning process includes wet spinning and/or melt spinning and/or gel spinning.

One aspect of some embodiments of the invention relates to the physical structure of lignin particles. In some exemplary embodiments of the invention, particles of lignin tend to retain a “woody” structure. Optionally, this woody structure is characterized by elongate flattish pieces and/or hollow tubes passing through the individual pieces.

One aspect of some embodiments of the invention relates to the ash content of the lignin. In some exemplary embodiments of the invention, the ash content is less than 1%, 0.9%, 0.8%, 0.7%, 0.6%, 0.5%, 0.4%, 0.3%, 0.38% on a dry matter basis. Alternatively or additionally, sulfur content is less than 0.5%. 0.1%, 0.07%, 0.05%, 0.03% on a dry matter basis. Optionally, ash components include one or more of aluminum, calcium, iron, potassium, magnesium, sodium, sulfur, silicon and zinc.

One aspect of some embodiments of the invention relates to the elemental ratio of lignin in the composition. In some exemplary embodiments of the invention, there are 9 to 12 hydrogen molecules and/or 1 to 5 oxygen molecules for every 9 carbon molecules in the lignin.

One aspect of some embodiments of the invention relates to a differential scanning calorimeter profile (DSC) of lignin in the composition. In some exemplary embodiments of the invention, the lignin is characterized by an endotherm between 130 and 250° C. Optionally, this endotherm may indicate a softening point of the lignin.

One aspect of some embodiments of the invention relates to lignin characterized by a low degree of solubility. For example, lignin according to some exemplary embodiments of the invention, may be characterized by a solubility of less than 5% in MF25 (2-(2-ethoxyethoxy) ethylacetate) and/or less than 15% in DMC (dimethylformamide) and/or less than 19% in DMSO (dimethylsulfoxide). In some exemplary embodiments of the invention, lignin exhibits a relatively low solubility in an alkaline media, such as 5% NaOH in water, at a temperature lower than 80° C.

It will be appreciated that some of the aspects described above relate to solution of technical problems associated with lignin purification (e.g. separation of lignin from residual contaminants such as HCl and/or ash and/or soluble carbohydrates).

It will be appreciated that some of the aspects described above relate to solution of technical problems associated with use of lignin as an input material for downstream industrial processes (e.g. production of fiber based materials using lignin as a starting material).

In some exemplary embodiments of the invention, there is provided a lignin composition characterized (on a dry matter basis) by at least one characteristic selected from the group consisting of: (a) a formula of C₉H_{X}O_{Y}; wherein X is at least 9 and Y is less than 5; (b) a chloride (Cl) content of at least 0.05%; (c) a chloride (Cl) content of less than 1%; (d) a covalently bound chlorine (Cl) content of at least 10 PPM; (e) an O/C ratio less than 0.34; (f) an O/C ratio less than previously reported for lignin from a same specific lignocellulosic source; (g) an H/C ratio less than 2; (h) a solubility of less than 30% in DMSO (dimethylsulfoxide) at room temperature after high shear mixing; (i) a solubility of less than 20% in DMF (dimethylformamide) at room temperature after high shear mixing; (j) an ash content of less than 0.5%; (k) a sulfur content of less than 70 PPM; (l) a phosphorus content of less than 100 PPM; (m) a soluble carbohydrate content of less than 5%; (n) a marker molecule content of at least 10 PPM; (o) a furfurals content of at least 10 PPM; (p) a detectable amount (e.g. at least 100 PPB) of hydroxymethyl furfural; (q) containing furfurals including oligomers of 3 to 10 furfural units; (r) a lignin decomposition products (LDP) content of less than 1000 PPM; (s) an LDP content of at least 100 PPB, wherein said LDP includes at least one member of the group consisting of pyrolytic oils, phenols, aldehydes and aliphatic compounds; (t) a residual S1 solvent content of at least 1 PPM; (u) at least 10 PPB of a lignin polymer bound to an alcohol of at least 6 carbon atoms by an ether bond; (v) a tall oil content of less than 0.5%; (w) a dry basis content of carboxylic functions greater than 0.05%; (x) at least 75% of lignin in the composition having molecular weight greater than 50 kDa (kiloDaltons); (y) presence of lignin particles characterized by lengthwise tubules with a transverse cross-sectional dimension of at least 5 microns; (z) a solubility of less than 10% in 2-(2-ethoxyethoxy) ethylacetate at room temperature after high shear mixing; (aa) less than 0.1% conversion into phenolics after incubation at 121° C. for 1 h in 3% H₂SO₄; (ab) less than 0.1% conversion into phenolics after incubation at 121° C. for 3 h in 48% HBr; (ac) a solubility of less than 20% in aqueous 5% NaOH solution after incubation for 3 hours at 75° C.; (ad) less than 0.1 times the amount of volatile sulfur compounds found in Kraft lignin; (ae) an energy value of at least 5950, optionally at least 6000 cal/gram as measured by ASTM D240 calorimetry; and (af) total non lignin components ≦3%; wherein said composition is provided as a solid.

In some embodiments, the composition is characterized by at least two of the characteristics from the group. In some embodiments, the composition is characterized by at least three of the characteristics from the group. In some embodiments, the composition is characterized by at least at least four, of the characteristics from the group. In some embodiments, the composition is characterized by at least five, six, seven or an even larger number of the characteristics from the group. Alternatively or additionally, in some embodiments the composition is provided as a solid. Alternatively or additionally, in some embodiments the composition is provided as fibers. Alternatively or additionally, in some embodiments the composition is provided as a solution. Alternatively or additionally, in some embodiments the composition is provided as a suspension in a main solvent. Alternatively or additionally, in some embodiments the main solvent includes at least one of water and a water-soluble solvent. Alternatively or additionally, in some embodiments the composition is prepared from a substrate comprising hardwood. Alternatively or additionally, in some embodiments the composition is prepared from a substrate comprising softwood. Alternatively or additionally, in some embodiments the composition is prepared from a substrate comprising hardwood and softwood. Alternatively or additionally, in some embodiments there is provided a product including a lignin composition as described herein and other ingredients. According to various exemplary embodiments of the invention the product is selected from the group consisting of: carbon fibers, protective coatings, lignosulfonates, bio-oils, carboxylic and fatty acids, dicarboxylic acids, hydroxyl-carboxylic, hydroxyl di-carboxylic acids and hydroxyl-fatty acids, methylglyoxal, mono-, di- or poly-alcohols, alkanes, alkenes, aromatics, aldehydes, ketones, esters, biopolymers, proteins, peptides, amino acids, vitamins, antibiotics, paraxylene, pharmaceuticals, dispersants, emulsifiers, complexants, flocculants, agglomerants, pelletizing additives, resins, active carbon, antioxidants, liquid fuels, aromatic chemicals, vanillin, adhesives, binders, absorbents, toxin binders, foams, films, rubbers, elastomers, sequestrants, solid fuels, expanders a liquid fuels, paints, dyes, glues, plastics, wet spun fibers, melt spun fibers and flame retardants. Alternatively or additionally, in some exemplary embodiments of the invention, there is provided a viscous paste including a lignin composition as described herein.

In some exemplary embodiments of the invention, there is provided a lignin formulation including: (a) solid lignin (optionally finely milled); and (b) lignin in solution at a controlled concentration. In some exemplary embodiments of the invention, there is provided a lignin formulation including: (a) lignin in solution at a controlled concentration and (b) positively charged particles suspended in the solution. In some embodiments, the positively charged particles include metal oxides. In some embodiments, the metal oxides include at least one of TiO₂ and Al₂O₃.

In some exemplary embodiments of the invention, there is provided a method for the production of a lignin composition according as described herein including: (a) generating a solid composition including lignin and less than 5% hemicellulose sugars; and (b) solubilizing lignin in the composition to form a lignin solution. In some embodiments, the generating includes: providing a lignocellulosic substrate; and removing at least a portion of ash, tall oils and hemicellulose sugars from the substrate. Alternatively or additionally, in some embodiments the solid composition includes cellulose and the solubilizing lignin leaves solid cellulose. Alternatively or additionally, in some embodiments the solid composition includes cellulose and the method includes: hydrolyzing cellulose using a mineral acid solution to form a sugar solution and solid lignin; and de-acidifying the solid lignin.

In some exemplary embodiments of the invention, there is provided a spinning method including, (a) providing a composition as described herein; (b) contacting the composition with an anti-solvent so that the lignin begins to solidify; (c) spinning the lignin to produce fibers. In some embodiments, the method includes removing the antisolvent from the fibers.

In some exemplary embodiments of the invention, there is provided a spinning method including: (a) providing a composition as described above; (b) softening (optionally melting) lignin in the composition; and (c) spinning and cooling the lignin to produce fibers. In some embodiments, the softening is conducted in the presence of plasticizers.

In some exemplary embodiments of the invention, there is provided a spinning method including: (a) providing a composition as described above; (b) spinning the lignin to produce fibers; and (c) drying the fibers as they are formed.

In some embodiments, one or more of the spinning methods described above includes carbonizing the fibers to produce carbon fibers. Some exemplary embodiments of the invention, a lignin fiber and/or carbon fiber produced by a method as described above. Alternatively or additionally, some embodiments of the invention relate to a fabric including a fiber as described above. Alternatively or additionally, some embodiments of the invention relate to an insulation material including a fiber as described above. Alternatively or additionally, some embodiments of the invention relate to a composite material including a polymer including one or more materials selected from the group consisting of epoxy, polyester, vinyl ester and nylon reinforced with fibers as described above.

In some exemplary embodiments of the invention, there is provided lignin characterized by a formula of C₉H_{X}O_{Y}; wherein X is at least 9 and Y is less than 5.

Optionally, Y is less than 3, optionally less than 2.5, optionally less than 2.

In some exemplary embodiments of the invention, there is provided lignin characterized by a chloride (Cl) content of at least 0.05%, optionally at least 0.1%, optionally at least 0.2%.

In some exemplary embodiments of the invention, there is provided lignin characterized by a chloride (Cl) content of less than 1%, optionally less than 0.8%, optionally less than 0.5%.

In some exemplary embodiments of the invention, there is provided lignin characterized by a covalently bound chlorine (Cl) content of at least 10 PPM, optionally 25 PPM, optionally 50 PPM, optionally 100 PPM.

In some exemplary embodiments of the invention, there is provided lignin characterized by an O/C ratio of less than 0.34, optionally less than 0.3, optionally less than 0.25.

In some exemplary embodiments of the invention, there is provided lignin from a specific lignocellulosic source characterized by an O/C ratio less than previously reported for lignin from the same specific lignocellulosic source.

In some exemplary embodiments of the invention, there is provided lignin characterized by a solubility of less than 30% in DMSO (dimethylsulfoxide) at room temperature after high shear mixing. Optionally, the solubility in DMSO is less than 20%.

Optionally, the lignin is characterized by a solubility of less than 20% in DMF (dimethylformamide) at room temperature after high shear mixing. Optionally, the solubility in DMF is less than 15%.

Optionally, the lignin is characterized by a solubility of less than 10% in 2-(2-ethoxyethoxy) ethylacetate at room temperature after high shear mixing. Optionally, the solubility in 2-(2-ethoxyethoxy) ethylacetate is less than 5%.

In some exemplary embodiments of the invention, there is provided lignin characterized by no detectable release of phenolics after incubation at 121° C. for 1 hour in 3% H₂SO₄.

In some exemplary embodiments of the invention, there is provided lignin characterized by a solubility of less than 30% in DMSO (dimethylsulfoxide) at room temperature after high shear mixing after the incubation.

In some exemplary embodiments of the invention, there is provided lignin characterized by no detectable release of phenolics after incubation at 121° C. for 3 hours in 48% HBr.

Optionally, the lignin is characterized by a solubility of less than 30% in DMSO (dimethylsulfoxide) at room temperature after high shear mixing after the incubation.

Optionally, the lignin is characterized by a solubility of less than 20, optionally less than 15, optionally less than 10% in 5% NaOH in water after incubation for 3 hours at 75° C.

In some exemplary embodiments of the invention, there is provided lignin characterized by an ash content of less than 0.5%, optionally less than 0.4%, optionally less than 0.3%, optionally less than 0.2%, optionally less than 0.1%.

In some exemplary embodiments of the invention, there is provided lignin characterized by a sulfur content of less than 0.07%, optionally less than 0.05%, optionally less than 0.03%.

In some exemplary embodiments of the invention, there is provided lignin characterized by a phosphorus content of less than 100 PPM, optionally less than 50 PPM, optionally less than 25 PPM, optionally less than 10 PPM, optionally less than 1 PPM, optionally less than 0.1 PPM, optionally less than 0.01 PPM.

In some exemplary embodiments of the invention, there is provided lignin characterized by a soluble carbohydrate content of less than 5%, optionally 3%, optionally 2%, optionally 1%.

In some exemplary embodiments of the invention, there is provided lignin including one or more furfurals at a total concentration of at least 10 PPM, optionally at least 25 PPM, optionally at least 50 PPM, optionally at least 100 PPM. Optionally, the furfurals include hydroxymethyl furfural. Optionally, the furfurals include oligomers of 3 to 10 furfural units.

In some exemplary embodiments of the invention, there is provided lignin including at least at least 10, optionally at least 20, optionally at least 50, optionally at least 100 PPM of S1 solvent. Optionally, the S1 solvent includes hexanol and/or 2-ethyl-1-hexanol.

In some exemplary embodiments of the invention, there is provided a lignin particle characterized by lengthwise tubules with a transverse cross-sectional dimension of at least 5 microns. Optionally, the transverse cross-sectional dimension is less than 20 microns. Optionally, the tubules are characterized by an aspect ratio of transverse cross-sectional dimension to length less than 0.1. Optionally, the aspect ratio is less than 0.025.

In some exemplary embodiments of the invention, there is provided a population of lignin particles, wherein at least 0.1% of particles in the population are particles as described above.

In some exemplary embodiments of the invention, there is provided a composition including lignin and cellulose and having an elemental formula of C₉H_{11.78}O_{4.24}.

In some exemplary embodiments of the invention, there is provided a composition including lignin and cellulose and having an elemental formula of C₉H_{11.25}O_{3.68}.

In some exemplary embodiments of the invention, there is provided a composition including lignin and cellulose and having an elemental formula of C₉H_{10.72}O_{3.11}.

In some exemplary embodiments of the invention, there is provided a composition including lignin and cellulose and having an elemental formula of C₉H_{10.18}O_{2.55}.

In some exemplary embodiments of the invention, there is provided a composition including lignin and less than 20% non-lignin material (e.g. cellulose and/or ash). In some embodiments, the composition includes less than 15% non-lignin material. In some embodiments, the composition includes less than 10% non-lignin material. In some embodiments, the composition includes less than 5% non-lignin material. In some embodiments, the composition includes less than 3% non-lignin material. In some embodiments, the composition includes less than 1% non-lignin material.

In some exemplary embodiments of the invention, there is provided a molecule including a lignin polymer bound to an alcohol of at least 6 carbons by an ether bond.

In some exemplary embodiments of the invention, there is provided a method including: providing an input material including lignin as described above and/or lignin particles as described above and/or a composition as described above and/or molecules as described above; and processing the input material to produce a processed product. Optionally, the processed product includes one or more members selected from the group consisting of carbon fibers, activated carbon, activated carbon fibers, absorbent materials, coatings, phenol resins, adhesives, dispersants, flocculants, phenols, terphthalate, epoxies, BTX (Benzene/Toluene/Xylene), liquid fuels, polyols and polyolefins.

In some exemplary embodiments of the invention, there is provided a processed product produced by a method as described above.

In some exemplary embodiments of the invention, there is provided a method including: providing a processed product as described above; and subjecting the processed product to an industrial process to produce a downstream product.

Optionally, the downstream product is selected from the group consisting of a hygienic pad, a diaper and a wound dressing, sports equipment, a structural component, a paint and a dye.

In some exemplary embodiments of the invention, there is provided a downstream product produced by a method as described above.

In some exemplary embodiments of the invention, there is provided a method including providing a processed product as described above; and using the processed product as an ingredient or component in a downstream product. Optionally, the downstream product is selected from the group consisting of a liquid fuel, a paint, a dye, a glue and a plastic. In some exemplary embodiments of the invention, there is provided a downstream product produced by a method as described above.

In some exemplary embodiments of the invention, there is provided a lignin composition characterized (on a dry matter basis) by at least one characteristic selected from the group consisting of: (a) a formula of C₉H_{X}O_{Y}; wherein X is at least 9 and Y is less than 5; (b) a chloride (Cl) content of at least 50 PPM; (c) a chloride (Cl) content of less than 1%; (d) a covalently bound chlorine (Cl) content of at least 10 PPB; (e) an O/C ratio of less than 0.34; (f) an O/C ratio less than previously reported for lignin from a same specific lignocellulosic source; (g) an H/C ratio of less than 2; (h) a solubility of less than 30% in DMSO (dimethylsulfoxide) at room temperature after high shear mixing; (i) a solubility of less than 20% in DMF (dimethylformamide) at room temperature after high shear mixing; (j) an ash content of less than 0.5%; (k) a sulfur content of less than 70 PPM %; (1) a phosphorus content of less than 100 PPM; (m) a soluble carbohydrate content of less than 5%; (n) a marker molecule content of at least 10 PPM; (o) a furfurals content of at least 10 PPM; (p) hydroxymethyl furfural content of at least 100 PPB; (q) containing furfurals including oligomers of 3 to 10 furfural units; (r) a lignin decomposition products (LDP) content of less than 1000 PPM; (s) an LDP content of at least 100 PPB, wherein the LDP includes at least one member of the group consisting of pyrolytic oils, phenols, aldehydes and aliphatic compounds; (t) a residual S1 solvent content of at least 1 PPM; (u) at least 10 PPB of a lignin polymer bound to an alcohol of at least 6 carbon atoms by an ether bond; (v) a tall oil content of less than 0.5%; (w) at least 75% of the lignin having molecular weight greater than 50 kDa; (x) at least 0.1% of the lignin having particles characterized by lengthwise tubules with a transverse cross-sectional dimension of at least 5 microns; (y) a solubility of less than 10% in 2-(2-ethoxyethoxy) ethylacetate at room temperature after high shear mixing; (z) less than 0.1% conversion into phenolics after incubation at 121° C. for 1 h in 3% H₂SO₄; (aa) less than 0.1% conversion into phenolics after incubation at 121° C. for 3 h in 48% HBr; (ab) a solubility of less than 20% in aqueous 5% NaOH solution after incubation for 3 hours at 75° C.; (ac) less than 0.1 times the amount of volatile sulfur compounds found in Kraft lignin; (ad) an energy value of at least 6000 cal/gram as measured by ASTM D240 calorimetry; and (ae) total non lignin components ≦5%; wherein the composition is provided as a solid. In some embodiments, the composition includes (i) less than 3% non-lignin material; (ii) an ash content of less than 0.1%; (iii) a total carbohydrate content of less than 0.05%; (iv) a non melting particulate content (>1 micron diameter; at 150° C.) of less than 0.05%; and (v) a volatiles content of less than 5% at 200° C. In some embodiments, the composition includes at least two of the characteristics from the group. In some embodiments, the composition includes at least three of the characteristics from the group. In some embodiments, the composition includes at least four of the characteristics from the group. In some embodiments, the composition includes at least five of the characteristics from the group. Alternatively or additionally, in some embodiments the composition is provided as fibers. Alternatively or additionally, in some embodiments the composition is provided as a suspension in a main solvent. Alternatively or additionally, in some embodiments the main solvent includes at least one of water and a water-soluble solvent. Alternatively or additionally, in some embodiments the composition is prepared from a substrate includes hardwood. Alternatively or additionally, in some embodiments the composition is prepared from a substrate includes softwood. Alternatively or additionally, in some embodiments the composition is prepared from a substrate includes hardwood and softwood. In some exemplary embodiments of the invention, there is provided a product including a lignin composition as described herein and one or more other ingredients. According to various exemplary embodiments of the invention the product is selected from the group consisting of: carbon fibers, protective coatings, lignosulfonates, pharmaceuticals, dispersants, emulsifiers, complexants, flocculants, agglomerants, pelletizing additives, resins, adhesives, binders, absorbents, toxin binders, films, rubbers, elastomers, sequestrants, solid fuels, paints, dyes, plastics, wet spun fibers, melt spun fibers and flame retardants. Alternatively or additionally, in some embodiments there is provided a viscous paste, the paste including a lignin composition as described above. Alternatively or additionally, in some embodiments there is provided a lignin formulation as described herein including: (a) solid lignin; and (b) lignin in solution at a controlled concentration. Alternatively or additionally, in some embodiments there is provided a spinning method including: (a) providing a composition as described herein; (b) softening lignin in the composition; and (c) spinning and cooling the lignin to produce fibers. In some embodiments, the softening is conducted in the presence of plasticizers. Alternatively or additionally, in some embodiments method includes softening a synthetic polymeric material with the lignin. Alternatively or additionally, in some embodiments the synthetic polymeric material includes polyacrylonitrile (PAN). Alternatively or additionally, in some embodiments a ratio of lignin:synthetic polymer is ≧1:10. Alternatively or additionally, in some embodiments a ratio of lignin:synthetic polymer is ≦10:1. Alternatively or additionally, in some embodiments the method includes carbonizing the fibers to produce carbon fibers. In some exemplary embodiments of the invention, there is provided a fiber produced by a method as described herein. In some exemplary embodiments of the invention, there is provided a product selected from the group consisting of: a non woven fabric, a woven fabric, insulation material, sports equipment, automotive parts, airplane or helicopter parts, boat hulls or portions thereof and loudspeakers. In some exemplary embodiments of the invention, there is provided a fiber according as described herein. In some exemplary embodiments of the invention, there is provided a composite material including a polymer including one or more materials selected from the group consisting of epoxy, polyester, vinyl ester and nylon reinforced with fibers as described herein. In some exemplary embodiments of the invention, there is provided a lignin particle characterized by lengthwise tubules with a transverse cross-sectional dimension of at least 5 microns. In some embodiments, the transverse cross-sectional dimension is less than 20 microns. Alternatively or additionally, in some embodiments the tubules are characterized by an aspect ratio of transverse cross-sectional dimension to length less than 0.1. Alternatively or additionally, in some embodiments the aspect ratio is less than 0.025. Alternatively or additionally, in some embodiments at least 0.1% of particles in the population are particles as described herein. Alternatively or additionally, in some embodiments the composition includes lignin particles according as described herein and less than 20% cellulose. Alternatively or additionally, in some embodiments the composition includes less than 15% cellulose. Alternatively or additionally, in some embodiments the composition includes less than 10% cellulose. Alternatively or additionally, in some embodiments the composition includes less than 5% cellulose. In some exemplary embodiments of the invention, there is provided a method including: providing an input material includes a lignin composition as described herein and/or a viscous paste as described herein and/or a lignin formulation as described herein and/or particles as described herein; and processing the input material to produce a processed product. According to various exemplary embodiments of the invention the processed product includes one or more members selected from the group consisting of carbon fibers, activated carbon, activated carbon fibers, absorbent materials, coatings, phenol resins, adhesives, dispersants, flocculants, phenols, terphthalate, epoxies, Benzene/Toluene/Xylene (BTX), liquid fuels, polyols and polyolefins. In some exemplary embodiments of the invention, there is provided a processed product produced by a method as described herein. In some exemplary embodiments of the invention, there is provided a method including: providing a processed product as described herein; and subjecting the processed product to an industrial process to produce a downstream product. According to various exemplary embodiments of the invention the downstream product is selected from the group consisting of a hygienic pad, a diaper and a wound dressing, sports equipment, a structural component, a paint and a dye. In some exemplary embodiments of the invention, there is provided a downstream product produced by a method as described herein. In some exemplary embodiments of the invention, there is provided a method including: providing a processed product as described herein; and using the processed product as an ingredient or component in a downstream product. According to various exemplary embodiments of the invention the downstream product is selected from the group consisting of a liquid fuel, a paint, a dye, a glue and a polymeric material-containing article. In some exemplary embodiments of the invention, there is provided a downstream product produced by a method as described herein. In some exemplary embodiments of the invention, there is provided a composition including: (a) synthetic polymeric material; and (b) a lignin composition as described herein; wherein the lignin to synthetic polymer ratio is ≦0.67. In some embodiments, lignin includes ≧10% of the composition by weight. Alternatively or additionally, in some embodiments lignin includes ≦40% of the composition by weight. Alternatively or additionally, in some embodiments the composition has an ASTM D-3418 DSC transition temperature at least 3° C. higher than the transition temperature of the synthetic polymer. Alternatively or additionally, in some embodiments the composition meets the requirements of UL (Underwriters Laboratories) 94 V-2 for flame retardation. Alternatively or additionally, in some embodiments the composition includes: at least 30% synthetic polymeric material; at least 5% flame retardant; and at least 10% lignin. Alternatively or additionally, in some embodiments the composition includes at least 38% synthetic polymeric material; at least 10% flame retardant; and at least 14% lignin. Alternatively or additionally, in some embodiments the composition includes at least one item selected from the group consisting of magnesium hydroxide, melamine phosphate, pentaerythritol and triphenylphosphate. Alternatively or additionally, in some embodiments the synthetic polymeric material includes one or more members of the group consisting of polypropylene, nylon and poly-acrylonitrile butadiene styrene (ABS). Alternatively or additionally, in some embodiments the composition has a rate of blooming which is at least 10% less than a composition identical to the composition recited herein except that Kraft lignin replaces the lignin according to an embodiment of the invention. Alternatively or additionally, in some embodiments the composition has a rate of UV degradation which is at least 10% less than a composition identical to the composition recited herein except that Kraft lignin replaces the lignin according to an embodiment of the invention. Alternatively or additionally, in some embodiments the composition has a shelf life which is at least 10% longer than a composition identical to the composition recited herein except that Kraft lignin replaces the lignin according to an embodiment of the invention. Alternatively or additionally, in some embodiments the composition has a specific gravity ≦1.06. In some exemplary embodiments of the invention, there is provided a manufacturing process including: (a) compounding a synthetic polymeric material with a lignin composition as described herein to produce a lignin containing material; and (b) processing the lignin containing material to produce a product. In some embodiments, the processing produces a product including at least one member of the group consisting of: construction materials, furniture, in-mold labeled products, co-injected products, co-extruded products, electronics housings, imitation wood panels, rugs and floor coverings. Alternatively or additionally, in some embodiments the compounding includes addition of at least one material selected from the group consisting of plasticizers, flame retardants and dyes. Alternatively or additionally, in some embodiments the compounding is conducted at ≧200° C. Alternatively or additionally, in some embodiments the manufacturing process, includes: placing the lignin containing material into a mold as part of the processing; and removing the lignin containing material from the mold; wherein an elapsed time between the placing and the removing is shorter than in an identical molding process conducted on the same synthetic polymeric material without lignin. In some exemplary embodiments of the invention, there is provided a product produced by a process as described herein. Alternatively or additionally, in some embodiments the lignin in the composition as described herein has a dry basis content of carboxylic functions greater than 0.05%.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Percentages (%) are W/W (weight per weight) unless otherwise indicated. In addition, percentages are expressed on a dry matter basis unless otherwise indicated.

As used in this specification and the accompanying claims the terms “solution” and “suspension” indicate the presence of at least one solute in at least one solvent. In the case of a suspension, a portion of the solute may (in some cases) be dissolved in the solvent in addition to the portion that is suspended in the solvent. For example, successive addition of sugar to water will eventually produce a solution containing dissolved sugar at a high concentration which is also a suspension of undissolved sugar crystals. In other cases, a suspension is just a suspension. For example, adding sand to water produces only a suspension of sand grains, with virtually no dissolved sand.

Unless otherwise indicated, as used in this specification and the accompanying claims, the term “lignin” indicates any material including p-coumaryl alcohol and/or coniferyl alcohol and/or sinapyl alcohol, and/or short oligomers thereof and/or polymers thereof. Thus “lignin” includes solid polymeric lignin as well as partially or fully dissolved lignin.

As used in this specification and the accompanying claims the term “ash” refers to inorganic compounds, such as salts of alkali and alkaline-earth metals.

As used in this specification and the accompanying claims the term “reactive fluid” has the meaning ascribed to it in WO 2010/009343; paragraph [0058]:
“The term “reactive fluid” used herein means a fluid that is at a temperature higher than the boiling point of the liquid state of the fluid under atmospheric pressure (1 atm). The reactive fluid may be a liquid, a gas, a supercritical fluid, or a mixture of these. For example, water at a temperature above 100° C. and under atmospheric pressure is considered a reactive fluid. Supercritical, near critical, and sub-critical fluids are reactive fluids, illustrative examples including but not limited to sub-critical water, near critical water, supercritical water, supercritical ethanol, and supercritical CO₂.”

WO 2010/009343 is fully incorporated herein by reference.

“Aqueous-Phase Reforming” or “APR” indicates a catalytic reforming process that generates hydrogen-rich fuels from oxygenated compounds derived from biomass (e.g. glycerol, sugars, sugar alcohols, etc.). Various APR methods and techniques are described in U.S. Pat. No. 6,699,457; U.S. Pat. No. 6,953,873; U.S. Pat. No. 6,964,757; U.S. Pat. No. 6,964,758; U.S. Pat. No. 7,618,612 and PCT/US2006/048030; each of which is fully incorporated herein by reference. As used in this specification and the accompanying claims the terms “aqueous phase reforming” and “APR” generically denote the overall reaction of an oxygenated compound and water to yield a hydrogen stream, regardless of whether the reactions takes place in the gaseous phase or in the condensed liquid phase. “APR hydrogen” indicates hydrogen produced by the APR process. APR converts input oxygenated compounds to products including, but not limited to alcohols, ketones, aldehydes, alkanes, organic acids and furans.

Lignin decomposition products (LDPs) can be produced, for example, by pyrolysis and/or hydrogenolysis and/or oxidation and/or contact with a super-critical (or near super-critical) fluid such as water and/or another solvent or a mixture thereof. Exemplary methods for production of LDPs are reviewed by Pandey and Kim in “Lignin Depolymerization and Conversion: A Review of Thermochemical Methods” (Chem. Eng. Technol. (2011) 34 (1): 29-41) which is fully incorporated herein by reference. As used in this specification and the accompanying claims, the term “LDP” includes, but is not limited to phenols (e.g. phenol, catechol, guaiacol, syringol and cresol), aldehydes (e.g. vanillin and syringaldehyde) and aliphatics (e.g. methane, ethane and branched alkanes). As used in this specification and the accompanying claims the term LDP specifically excludes p-coumaryl alcohol, coniferyl alcohol and sinapyl alcohol which are “lignin”.

As used in this specification and the accompanying claims the term “S1” or “S1 solvent” or “first organic solvent” refers to a solvent which is less than 15% soluble in water and has a polarity related component of Hoy's cohesion parameter (delta-P) between 5 and 10 MPa^{1/2} and/or a hydrogen-bond related component of Hoy's cohesion parameter (delta-H) between 5 and 20 MPa^{1/2}. Optionally, S1 includes an alcohol, ketone or aldehyde with 5, optionally 6, or 8 or more carbon atoms. Optionally, S1 includes a hexanol, a heptanol or an octanol such as 2-ethyl-hexanol and combinations thereof

Delta-P is the polarity related component of Hoy's cohesion parameter and delta-H is the hydrogen bonding related component of Hoy's cohesion parameter.

The cohesion parameter, as referred to above or, solubility parameter, was defined by Hildebrand as the square root of the cohesive energy density:

$$δ = \sqrt{\frac{Δ {E}_{vap}}{V}}$$

where ΔEvap and V are the energy or heat of vaporization and molar volume of the liquid, respectively. Hansen extended the original Hildebrand parameter to a three-dimensional cohesion parameter. According to this concept, the total solubility parameter, delta, is composed of three different components, or, partial solubility parameters relating to the specific intermolecular interactions:

δ²=δ_{d}²+δₚ²+δₕ²

in which delta-D, delta-P and delta-H are the dispersion, polarity, and Hydrogen bonding components, respectively. Hoy proposed a system to estimate total and partial solubility parameters. The unit used for those parameters is MPa^{1/2}. A detailed explanation of that parameter and its components can be found in “CRC Handbook of Solubility Parameters and Other Cohesion Parameters”, second edition, pages 122-138. That and other references provide tables with the parameters for many compounds. In addition, methods for calculating those parameters are provided.

Exemplary S1 solvents include, but are not limited to, alcohols, ketones or aldehydes with 5, optionally 6, or 8 or more carbon atoms. Optionally, S1 includes a hexanol, a heptanol or an octanol such as 2-ethyl-hexanol and combinations thereof.

As used in this specification and the accompanying claims the term “volatiles” indicates materials which evaporate or sublime from a sample after incubation for five hours at a given temperature. A “volatiles content” for a given temperature can be determined by weighing the sample before and after the incubation.

As used in this specification and the accompanying claims the term “volatile sulfur compounds” indicates those sulfur compounds detectable by GCMS (Gas Chromatograpic Mass Spectography) from the headspace of a closed container in which a sample is incubated at 150° C. Lignin compositions according to some exemplary embodiments of the invention contain substantially no volatile sulfur compounds.

As used in this specification and the accompanying claims the terms “soluble carbohydrates” and “soluble sugars” are equivalent.

As used in this specification and the accompanying claims the term “blooming” indicates diffusion of a material through a polymer matrix towards the surface of an object comprising the matrix.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a schematic representation of a system for hydrolysis of lignocellulosic material;

FIG. 2 is a series of scanning electron micrographs (SEM) of lignin according to various exemplary embodiments of the invention: panels a, b and c depict a <200 mesh sieved fraction; panels d, e and f depict the same <200 mesh sieved fraction further treated with H₂SO₄; panels g, h, i and j depict the same <200 mesh sieved fraction further treated with HCl; panels k, l and m depict the same <200 mesh sieved fraction further treated enzymatically;

FIG. 3 is a series of scanning electron micrographs (SEM) (panels a through e) of lignin prepared according to the previously known Kraft process;

FIG. 4 is a differential scanning calorimetry (DSC) plot depicting heat flow in W/g as a function of temperature in degrees centigrade;

FIG. 5 is a scanning electron micrograph (SEM) of lignin with measurements of pore width superimposed;

FIG. 6 is a simplified flow diagram of a method according to some exemplary embodiments of the invention;

FIG. 7 is a simplified flow diagram of a method according to some exemplary embodiments of the invention;

FIG. 8 is a simplified flow diagram of a method according to some exemplary embodiments of the invention;

FIG. 9 is a simplified flow diagram of a method according to some exemplary embodiments of the invention;

FIG. 10 is a simplified flow diagram of a method according to some exemplary embodiments of the invention;

FIG. 11 is photograph of re-solidified lignin produced by injecting lignin in solution into an anti-solvent;

FIG. 12 is a simplified flow diagram of a method according to some exemplary embodiments of the invention; and

FIG. 13 is a series of scanning electron micrographs (SEM) of lignin according to exemplary embodiments of the invention after milling to ≦50 μm; panels a and c 1000× magnification; panels b and d 5000× magnification.

### DETAILED DESCRIPTION OF EMBODIMENTS

Embodiments of the invention relate to lignin compositions, products comprising those compositions, lignin formulations, methods to produce lignin compositions, and spinning methods which produce fibers from lignin.

Specifically, some embodiments of the invention can be used to produce para-xylene and/or liquid fuel and/or carbon fibers from lignin.

The principles and operation of a methods and/or compositions and/or products and/or fibers according to exemplary embodiments of the invention may be better understood with reference to the drawings and accompanying descriptions.

It is to be understood that the invention is not limited in its application to the details set forth in this description. The invention is capable of other embodiments or of being practiced or carried out in various ways. Also, it is to be understood that the phraseology and terminology employed herein is for the purpose of description and should not be regarded as limiting unless a closed definition of a specific term or phrase is provided.

### Exemplary System Overview

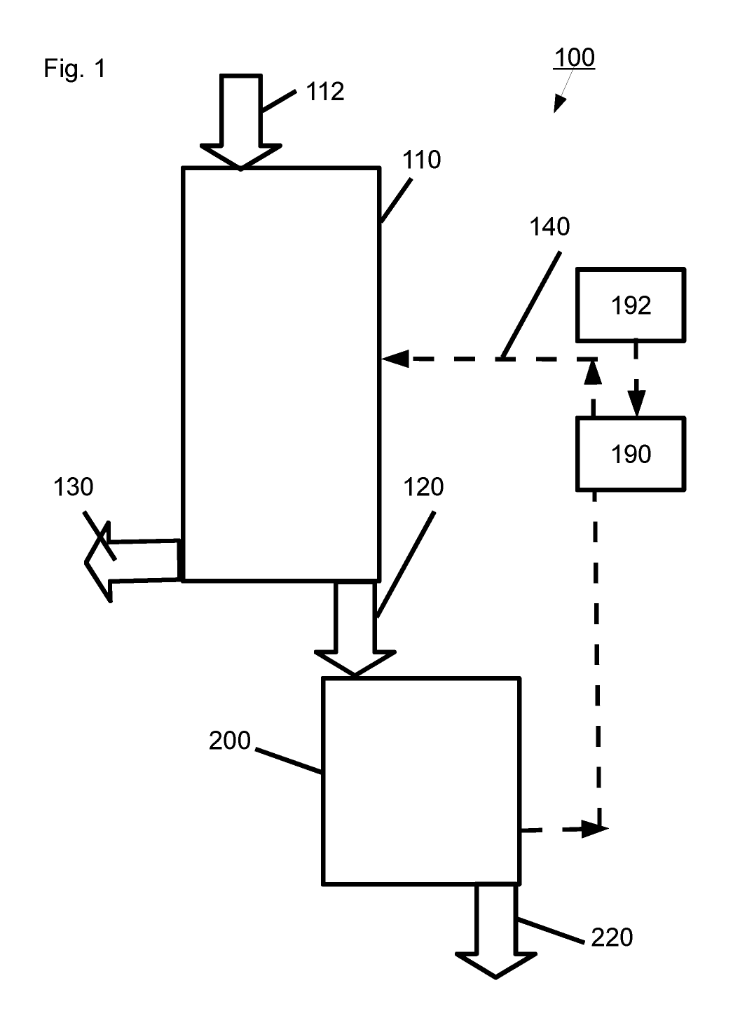

FIG. 1 is a schematic overview of an exemplary industrial context of some embodiments of the invention depicting relevant portions of an acid hydrolysis system for processing of lignocellulosic material indicated generally as 100. Depicted system 100 includes a hydrolysis vessel 110 which takes in lignocellulosic substrate 112 and produces two exit streams. The first exit stream is an acidic hydrolyzate 130 containing an aqueous solution of HCl with dissolved sugars. Other mineral acids (e.g. H₂SO₄) may also be used in addition to or in place of HCL in any of the embodiments described herein. The second exit stream 120 is a lignin stream. Lignin compositions containing lignin from stream 120 comprise some exemplary embodiments of the invention.

Optionally, hydrolysis vessel 110 is of a type described in co-pending application PCT/US2011/057552 filed Oct. 24, 2011 entitled “Hydrolysis Systems and Methods” which is fully incorporated herein by reference.

Alternatively or additionally, hydrolysis vessel 110 may include hydrolysis reactors of one or more other types.

FIG. 1 indicates that processing of lignin stream 120 occurs in lignin processing module 200 and produces lignin 220 which is substantially free of residual HCl and/or water and/or soluble carbohydrates. Optionally, lignin processing module 200 includes two or more sub-modules. For purposes of the overview of system 100, it is sufficient to note that module 200 produces a re-cycled stream 140 of concentrated HCl which is routed to hydrolysis vessel 110. In some exemplary embodiments of the invention, HCl gas 192 is added to stream 140 by means of an absorber 190. Optionally, the HCl gas is also produced by module 200.

Exemplary modules 200 are described in detail in co-pending application PCT/IL 2011/000424 filed on Jun. 1, 2011 by Robert JANSEN et al. and entitled “LIGNIN COMPOSITIONS, SYSTEMS AND METHODS FOR PROCESSING LIGNIN AND/OR HCl” which is fully incorporated herein by reference.

Some embodiments of the invention deal with various downstream processes applied to lignin 220 and resultant products of those processes.

### Exemplary Characteristics of Lignin Compositions

In some exemplary embodiments of the invention, a lignin composition is characterized (on a dry matter basis) by one, two, three, four, or even five or more characteristics presented in this section.

In some embodiments, the composition has a formula of C₉H_{X}O_{Y}; wherein X is at least 9 and Y is less than 5, less than 3, less than 2.5 or less than 2.

In some embodiments, the composition has a chloride (Cl) content of at least 0.1%, at least 0.2%, at least 0.5%, 1%, 2%, or 5%, or intermediate or greater percentages.

Alternatively or additionally, in some embodiments the composition has a chloride (Cl) content of at least 10 PPM, at least 25 PPM, at least 50 PPM, at least 100 PPM or intermediate or higher concentrations.

Alternatively or additionally, in some embodiments the composition has a chloride (Cl) content of less than 1%, less than 0.8%, less than 0.5% or intermediate or lower percentages.

Alternatively or additionally, in some embodiments the composition has a covalently bound chlorine (Cl) content of at least 10 PPB, optionally at least 1 PPM, optionally at least 10 PPM, optionally at least 25 PPM, optionally at least 50 PPM, optionally at least 100 PPM or intermediate or higher concentrations.

In some embodiments, the composition has an oxygen to carbon (O/C) ratio of less than 0.34 optionally less than 0.3, optionally less than 0.25 or intermediate or lower ratios.

Alternatively or additionally, in some embodiment the composition has an O/C ratio less than previously reported for lignin from a same specific lignocellulosic source.

In some embodiments, the lignin has a hydrogen to carbon (H/C) ratio less than 2. In some embodiments, the H/C ratio is less than 1.5 or even less than 1.25.

In some embodiments, the composition has a solubility of less than 30%, less than 20% or even less than 15% in DMSO (dimethylsulfoxide) at room temperature after high shear mixing.

In some embodiments, the composition has a solubility of less than 20%, less than 15% or even less than 10% in DMF (dimethylformamide) at room temperature after high shear mixing.

In some embodiments, the composition has an ash content of less than 0.5%, less than 0.4%, less than 0.3%, less than 0.2%, or even less than 0.1% or intermediate or lower percentages.

In some embodiments, the composition has a sulfur content of less than 0.07%, less than 0.05%, less than 0.03%, less than 0.02%, or even less than 0.01% or intermediate or lower percentages.

In some embodiments, the composition has a phosphorus content of less than 100 PPM, less than 50 PPM, less than 25 PPM, less than 10 PPM, less than 1 PPM, less than 0.1 PPM, or even less than 0.01 PPM or intermediate or lower concentrations.

In some embodiments, the composition has a soluble carbohydrate content of less than 5%, less than 3%, less than 2%, or even less than 1% or intermediate or lower percentages.

In some embodiments, the composition has a marker molecule, two or more marker molecules, three or more marker molecules or four or more marker molecules having content of at least 10 PPM. Marker molecules include, but are not limited to furfural and hydroxymethyl furfural, products of their condensation, color compounds, acetic acid, methanol, galcturonic acid, glycerol, fatty acids and resin acids.

In some embodiments, the composition has a furfurals content of at least 10 PPM, at least 25 PPM, at least 50 PPM, at least 100 PPM or intermediate or higher concentrations.

In some embodiments, the composition has a detectable amount of hydroxymethyl furfural.

In some embodiments, the composition contains furfurals including oligomers of 3 to 10 furfural units.

In some embodiments, the composition has an LDP content including at least one member of the group consisting of a pyrolytic oil, a phenol, an aldehyde and an aliphatic compound.

In some embodiments, the composition has a lignin decomposition products (LDP) content of less than 1000 PPM, less than 500 PPM, or even less than 200 PPM or intermediate or lower concentrations.

In some embodiments, the composition has an LDP content of ≧100 PPB, ≧250 PPB, ≧500 PPB, or even ≧1 PPM, wherein said LDP includes at least one member of the group consisting of pyrolytic oils, phenols, aldehydes and aliphatic compounds.

In some embodiments, the composition has an S1 solvent content of at least 10 PPM, at least 20, at least 50, or even at least 100 PPM or intermediate or greater concentrations.

In some embodiments, the composition is includes a lignin polymer bound to an alcohol of at least 6 carbons by an ether bond.

In some embodiments, the composition has a tall oil content of less than 0.5%, less than 0.25% or even less than 0.1% or intermediate or lower concentrations.

In some embodiments, the composition has a dry basis content of carboxylic functions greater than 0.05%, greater than 0.07% or even greater than 0.1%. As used in this specification and the accompanying claims the term “carboxylic” includes both carboxylic form (i.e. acid) and carboxylate form (i.e. salt).

In some embodiments, at least 75%, at least 80, at least 85, at least 90, at least 95 or even at least 97.5% of lignin in the composition has a molecular weight (MW) greater than 50 kDa. As used in this specification and the accompanying claims the terms “molecular weight” and “MW” indicate weights as measured by gel permeation chromatogtraphy (GPC) in high precision liquid chromatography (HPLC) with reference to standards of known MW. Measurement of molecular weight of solid lignin compositions optionally includes solubilization of lignin.

In some exemplary embodiments of the invention, lignin contains cellulose in the range of 20 to 25%. Optionally, this percentage can be reduced. Reduction strategies include, but are not limited to treatment with acid (e.g. HCl and/or H₂SO₄) and/or enzymatic treatment.

Exemplary Physical Forms

In some exemplary embodiments of the invention the lignin composition(s) as described above are provided as a solid. In some embodiments, the solid includes lignin fibers.

In some exemplary embodiments of the invention the lignin composition(s) as described above are provided as a solution. Alternatively or additionally, in some embodiments the lignin composition(s) as described above are provided as a suspension. According to various exemplary embodiments of the invention the solvent in the solution and/or suspension includes water and/or a water-soluble solvent. In some embodiments, the solvent includes 7 to 15% ammonia and/or 2 to 5% peroxide in water. Alternatively or additionally, in some embodiments the solvent includes 2 to 5% of a strong base (e.g. NaOH) and/or 0.0005 to 0.002% anthraquinone in water.

Exemplary Micro-Morphology of Lignin

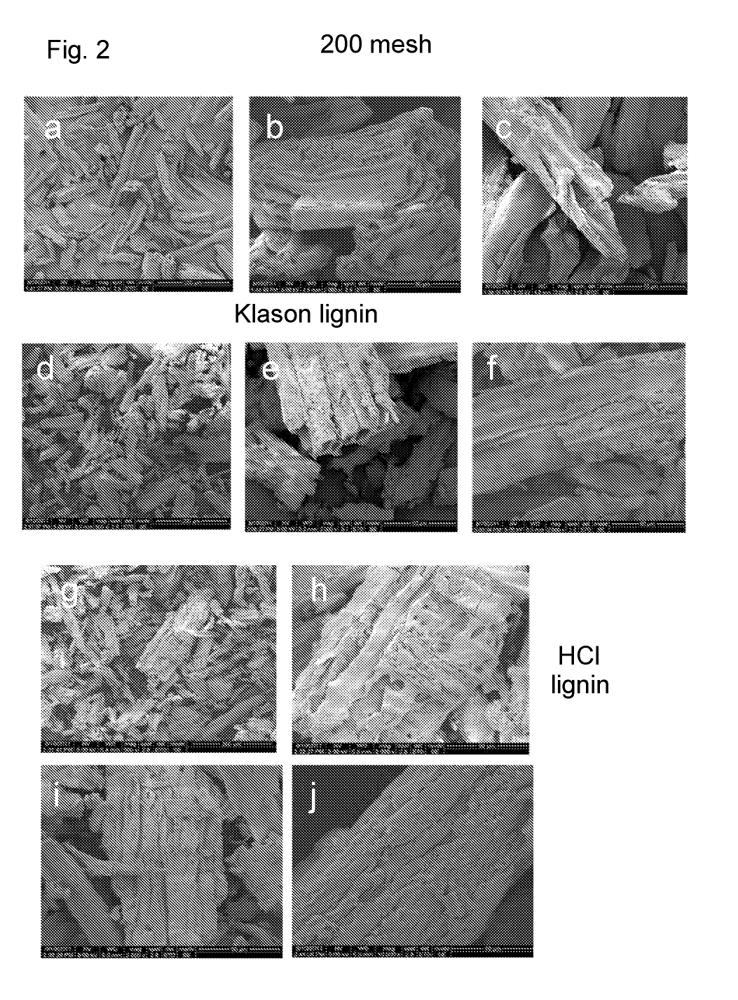

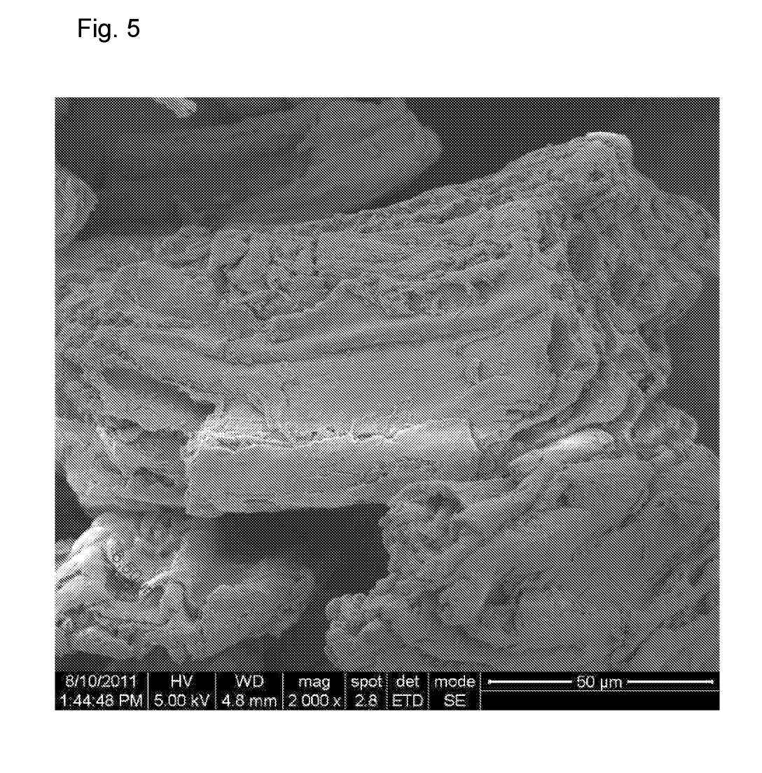

The micro-morphology of lignin according to various exemplary embodiments of the invention resembles wood (see FIG. 2). Specifically, in some exemplary embodiments of the invention, lignin has pores or tubules. These pores/tubules are described herein in Example 10 with reference to FIG. 5.

Lignin according to exemplary embodiments of the invention milled with a Retsch ball mill mixer to <50 um size (i.e. 90% of the sample ≦40 um) still exhibited the wood structure. Specifically, the particles retain an elongated and/or flattened appearance.

In some exemplary embodiments of the invention, exhibits a softening point in the range of 130-250° C. In some embodiments, inclusion of hardwood in substrate 112 sharpens the softening point so that the lignin exhibits more melt-like behavior.

Exemplary Lignin Products

In some exemplary embodiments of the invention, a lignin composition as described herein is provided as part of a product comprising other ingredients. Alternatively or additionally, in some embodiments, a lignin composition as described herein is used in preparation of another material or product. Examples of such materials/products include, but are not limited to, carbon fibers, protective coatings, lignosulfonates, bio-oils, carboxylic and fatty acids, dicarboxylic acids, hydroxyl-carboxylic, hydroxyl di-carboxylic acids and hydroxyl-fatty acids, methylglyoxal, mono-, di- or poly-alcohols, alkanes, alkenes, aromatics, aldehydes, ketones, esters, biopolymers, proteins, peptides, amino acids, vitamins, antibiotics, paraxylene, pharmaceuticals, dispersants, emulsifiers, complexants, flocculants, agglomerants, pelletizing additives, resins, antioxidants, liquid fuels, aromatic chemicals, vanillin, adhesives, binders, absorbents, toxin binders, foams, films, rubbers, elastomers, sequestrants, solid fuels, expanders a liquid fuels, paints, dyes, glues, plastics, wet spun fibers, melt spun fibers, flame retardants, activated carbon, activated carbon fibers, absorbent materials (e.g. in hygienic pads, diapers or wound dressings), phenol resins, phenols, terphthalates, epoxies, BTX (Benzene/Toluene/Xylene), polyols and polyolefins, each of which represents an additional exemplary embodiment of the invention.

Each of these materials/products represents an embodiment of the invention.

Alternatively or additionally, each of these materials or products can serve as a raw material for production of, and/or an ingredient in, other materials and/or products, each of which represents an additional exemplary embodiment of the invention.

In some exemplary embodiments of the invention, analysis of the amount of Cl, or covalently bound Cl, in a product provides an indication of the lignin source employed in its manufacture.

Alternatively or additionally, analysis of the amount of one or more marker molecules related to the lignin production process in a product may provide an indication of the lignin source employed in its manufacture. Exemplary marker molecules include, but are not limited to furfurals and/or S1 solvent residues. Optionally, furfurals maybe present as oligomers.

Alternatively or additionally, presence of an alcohol of at least 6 carbons bound to a lignin polymer by an ether bond in a product can be indicative of the source of the lignin used to prepare the product.

Alternatively or additionally, analysis of the C/H/O ratio in a product provides an indication of the lignin source employed in its manufacture.

### Exemplary Paste and its Use

Some exemplary embodiments of the invention, relate to a viscous paste including a lignin composition as described above. Such a paste can serve as a base for paints or coatings. Such pastes or coating are expected to be characterized by high UV absorption and/or flame retardant activity and/or bacteriostatic and/or bactericidal activity (e.g. against soil bacteria).

Exemplary Formulations and their Use

Some exemplary embodiments of the invention, relate to lignin formulations.

In some embodiments, a lignin formulation includes solid lignin (optionally finely milled); and lignin in solution at a controlled concentration. Formulations of this type are expected to find utility as coatings, as an input material for wet spinning of fibers, in preparation of carbon based electrodes and/or battery electrodes, in construction of fuel cells, in preparation of hydrogen holding devices and in preparation of carbon filters.

In some embodiments, a lignin formulation includes lignin in solution at a controlled concentration and positively charged particles suspended in the solution. Optionally, the positively charged particles include metal oxides. Exemplary metal oxides suitable for use in such formulations include, but are not limited to TiO₂ and/or Al₂O₃. Optionally, formulations of soluble lignin with such positively charges particles form gels applicable as bonding materials and/or fillers. Alternatively or additionally, such gels can serve as an input in a gel spinning process.

### Exemplary Lignin Processing Methods

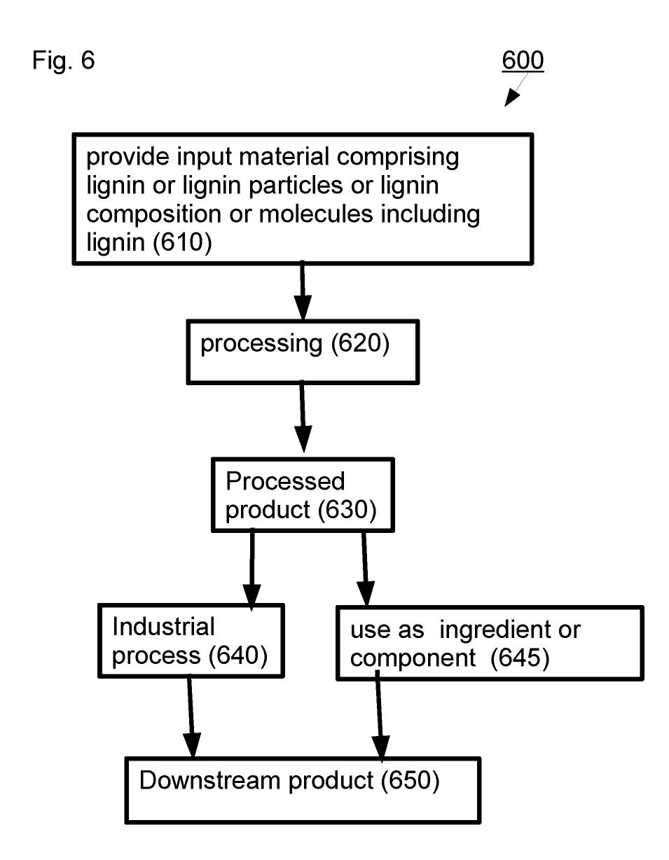

FIG. 6 depicts an exemplary method to process lignin into a product, indicated generally as 600. Depicted exemplary method 600 includes providing (610) an input material comprising lignin as described herein and/or lignin particles as described herein and/or a composition as described herein and/or molecules as described herein and processing (620) the input material to produce a processed product 630. Exemplary processed products 630 include, but are not limited to carbon fibers, activated carbon, activated carbon fibers, absorbent materials, coatings, phenol resins, adhesives, dispersants, flocculants, phenols, terphthalates, epoxies, BTX, liquid fuels, polyols and polyolefins.

Processed products 630 are exemplary embodiments of the invention.

FIG. 6 also depicts an exemplary method including providing a processed product 630 and subjecting processed product 630 to an industrial process 640 to produce a downstream product 650. Downstream products 650 include but are not limited to hygienic pads, diapers, wound dressings, sports equipment, structural components, paints and dyes.

Downstream products 650 are exemplary embodiments of the invention. FIG. 6 also depicts an exemplary method including providing a processed product 630 and using 645 processed product 630 as an ingredient or component in a downstream product 650. Downstream products 650 include, but are not limited to liquid fuels, paints, dyes, glues and plastics. Downstream products 650 are exemplary embodiments of the invention.

### Exemplary Method to Make a Composition

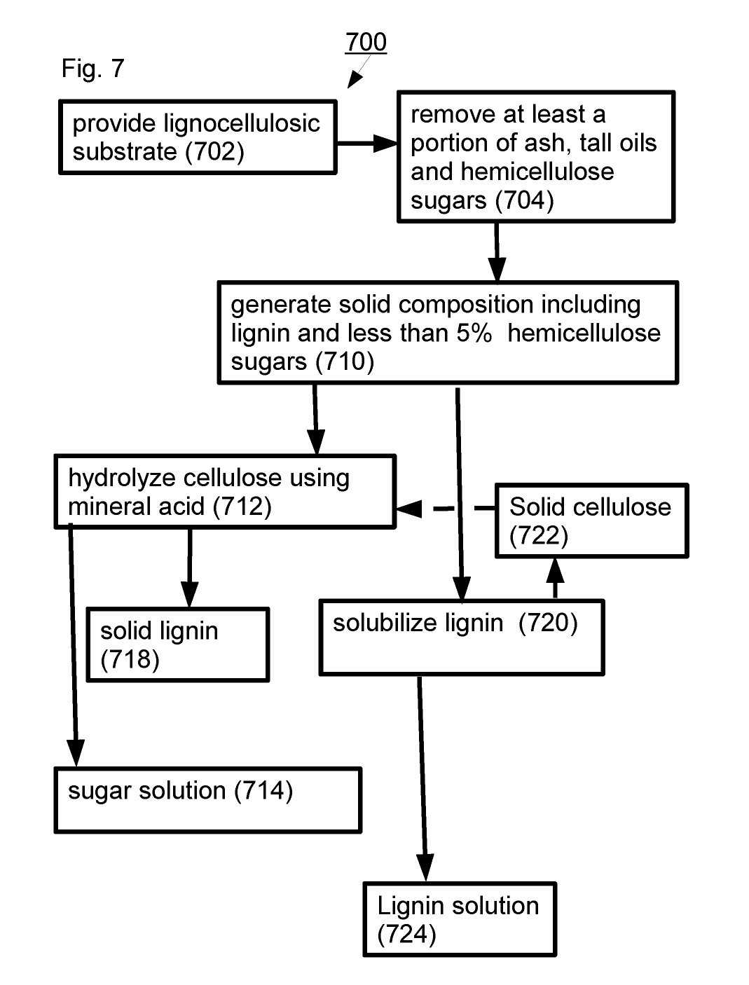

FIG. 7 is a simplified flow diagram of a method to prepare a lignin composition according to some exemplary embodiments of the invention indicated generally as method 700.

Depicted exemplary method 700 includes generating 710 a solid composition including lignin and less than 5%, optionally less than 3%, optionally less than 1% hemicellulose sugars solubilizing 720 lignin in the composition to form a lignin solution 724.

As used in this specification and the accompanying claims the term “hemicellulose sugars” refers to sugars indicative of hemicellulose, i.e. xylose, arabinose, mannose, galactose. mannuronic acid and galacturonic acid. According to various exemplary embodiments of the invention these hemicellulose sugars are present as polymers and/or oligomers and/or monomers. Optionally, the polymers and/or oligomers include other sugars (e.g. glucose). Optionally, solubilizing 720 employs NaOH and/or anthraquinone and/or ammonia and/or peroxide as described herein.

In some exemplary embodiments of the invention, generating 710 includes providing 702 a lignocellulosic substrate and removing 704 at least a portion of ash, tall oils and hemicellulose sugars from said substrate. Removing 704 can be, for example, as described in co-pending application PCT/US2011/064237.

In some exemplary embodiments of the invention, the solid composition includes cellulose and solubilizing 720 the lignin leaves solid cellulose 722. Optionally, solid cellulose 722 is hydrolyzed (e.g. with a mineral acid at 712).

In other exemplary embodiments of the invention, the solid composition includes cellulose and method 700 includes hydrolyzing 712 the cellulose using a mineral acid solution to form a sugar solution 714 and solid lignin 718 and de-acidifying (not depicted) solid lignin 718. Solid lignin 718 can then be solubilized 720.

In some exemplary embodiments of the invention, hydrolysis 712 is performed with HCl concentration of 30 to 44% as determined from HCl/[HCl+water]. Exemplary systems and methods for de-acidification of solid lignin 718 are described in co-pending PCT application PCT/IL2011/000424.

### Exemplary Spinning Methods

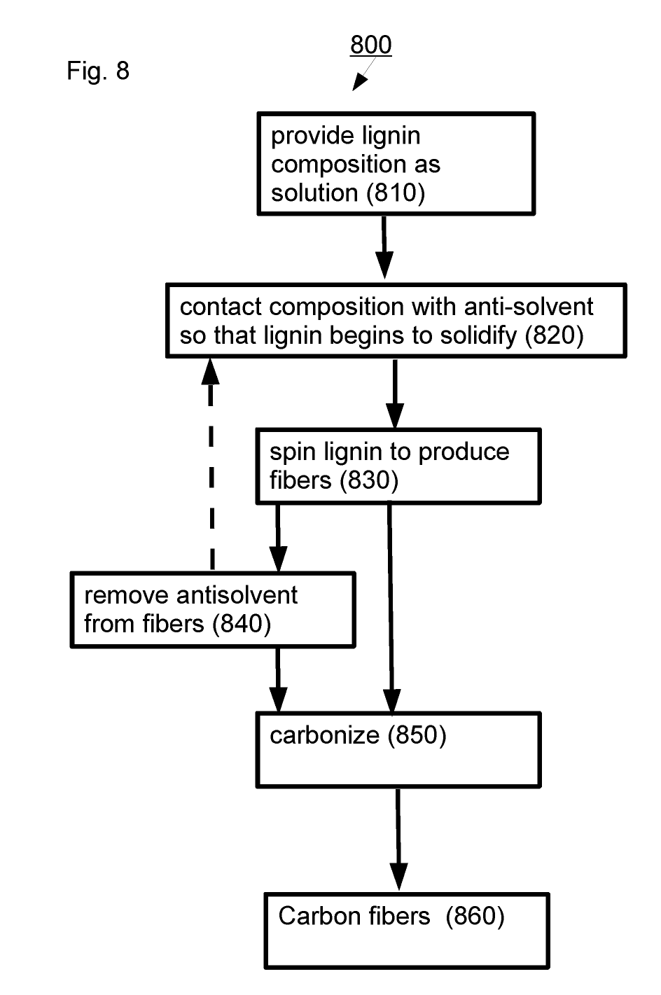

FIG. 8 is a simplified flow diagram of a wet spinning method according to some exemplary embodiments of the invention indicated generally as 800. Depicted exemplary method 800 includes providing 810 a lignin composition as described herein as a solution. Depicted method 800 also includes contacting 820 the composition with an anti-solvent so that the lignin begins to solidify and spinning 830 the lignin to produce fibers of lignin.

In some embodiments, method 800 includes removing 840 the antisolvent from the fibers. In some embodiments, antisolvent is removed by drying. Alternatively or additionally, the antisolvent is recovered and re-used at contacting 820 (dashed upward arrow).

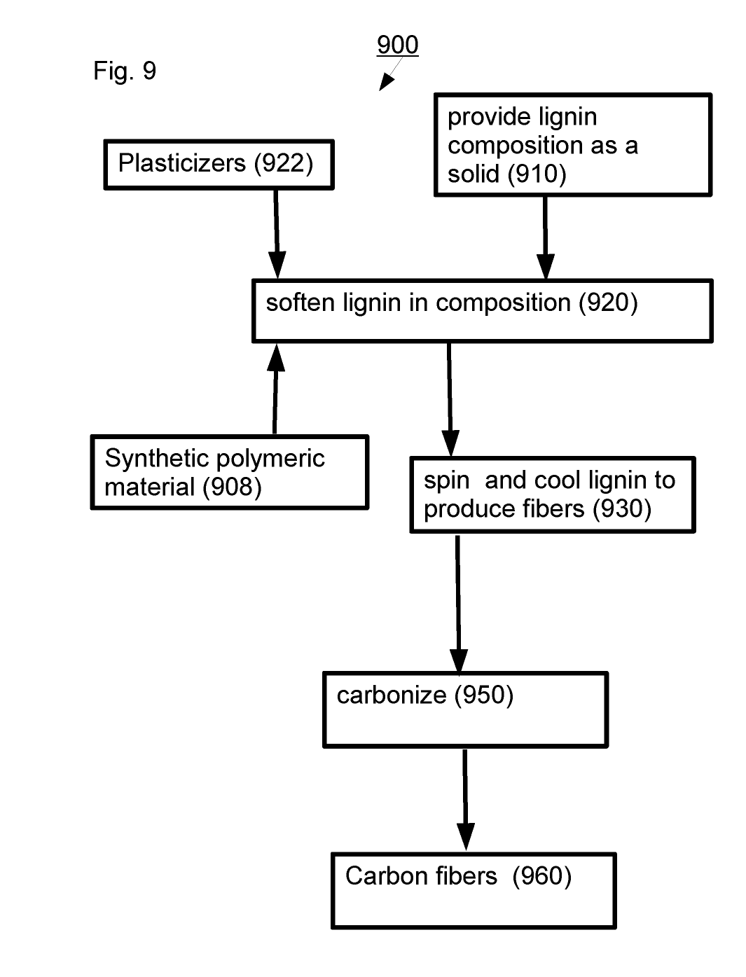

FIG. 9 is a simplified flow diagram of a melt spinning method according to some exemplary embodiments of the invention indicated generally as 900. Depicted exemplary method 900 includes providing 910 a lignin composition as a solid (e.g. milled, ground or powdered form) and softening (optionally melting) 920 lignin in the composition. In the depicted exemplary embodiment, method 900 includes spinning and cooling 930 the lignin to produce fibers of lignin. In some embodiments of method 900, softening 920 is conducted in the presence of plasticizers 922 as depicted. In some embodiments, providing 910 includes hydrolysis of a lignocellulosic substrate. In some embodiments, the substrate includes a hardwood (e.g. eucalyptus). In some embodiments, the substrate includes a mixture of hardwood and softwood (e.g. pine). In other embodiments, the substrate includes only hardwood. In other exemplary embodiments of the invention, the substrate includes only softwood.

Alternatively or additionally, in some exemplary embodiments of the invention, method 900 includes softening 920 (optionally melting) a synthetic polymeric material 908 with the lignin. According to these embodiments fibers produced at 930 are a mixture of lignin and synthetic polymeric material 908. Exemplary synthetic polymeric materials 908 include but are not limited to polypropylene, ABS, nylon and polyacrylonitrile (PAN). According to various exemplary embodiments of the invention the fibers have a lignin:synthetic polymer (e.g., PAN) ratio between about 1:10 and about 10:1.

In some exemplary embodiments of the invention, a ratio of lignin:synthetic polymer (e.g. PAN) in the fibers is ≧1:10; ≧1.5:10; ≧2:10; ≧2.5:10; ≧3:10 or; ≧3.5:10.

Alternatively or additionally, in some embodiments a ratio of lignin:synthetic polymer (e.g. PAN) in the fibers is ≦10:1; ≦9:1; ≦9:1; ≦5:1; ≦6:1; ≦50:1.

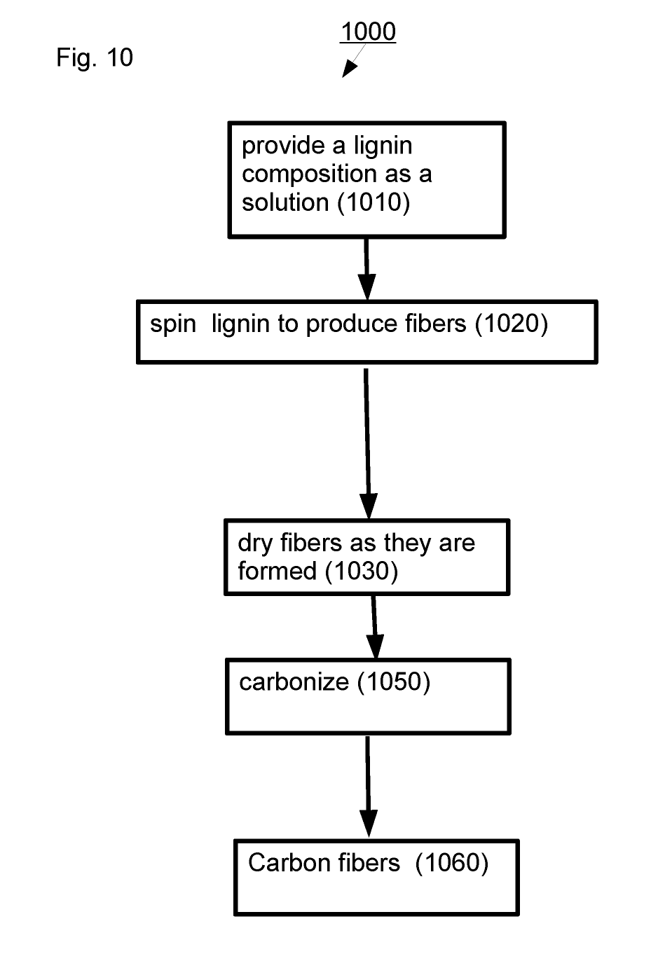

FIG. 10 is a simplified flow diagram of a dry spinning method according to some exemplary embodiments of the invention indicated generally as 1000. Depicted exemplary method 1000 includes providing 1010 a lignin composition as a solution, spinning 1020 to produce fibers of lignin and drying 1030 the fibers as they are formed.

In some exemplary embodiments of the invention, methods 800, 900 and 1000 end with production of lignin fibers as described above. In other exemplary embodiments of the invention, methods 800, 900 and 1000 transform the lignin fibers to carbon fibers (860, 960 and 1060 respectively) by carbonizing (850, 950 and 1050 respectively) the lignin fibers. In some exemplary embodiments of the invention, carbonizing (850, 950 and 1050 respectively) is performed on lignin fibers together with fibers of a synthetic polymeric material (e.g. polyacrylonitrile; PAN)

In some exemplary embodiments of the invention, a ratio of lignin:synthetic polymer (e.g. PAN) is ≧1:10; ≧1.5:10; ≧2:10; ≧2.5:10; ≧3:10 or; ≧3.5:10.

Alternatively or additionally, in some embodiments a ratio of lignin:synthetic polymer (e.g. PAN) is ≦10:1; ≦9:1; ≦9:1; ≦5:1; ≦6:1; ≦50:1.

Exemplary Products Including Fibers According to Various Embodiments of the Invention

Lignin fibers and/or carbon fibers produced by any of methods 800, 900 and 1000 are exemplary embodiments of the invention. In some exemplary embodiments of the invention, these fibers are incorporated into fabrics, and the resultant fabrics are exemplary embodiments of the invention. In some embodiments, such fabrics are more flame retardant than similar fabrics not including fibers according to an exemplary embodiment of the invention. In some exemplary embodiments of the invention, these fibers are incorporated into an insulation material. In some embodiments, such insulation materials are more flame retardant than similar insulation materials not including fibers according to an exemplary embodiment of the invention.

According to various exemplary embodiments of the invention product are produced from the described lignin fibers. Such products include, but are not limited to, non woven fabric, woven fabric, insulation material, sports equipment, automotive parts, airplane or helicopter parts, boat hulls or portions thereof and loudspeakers.

In some exemplary embodiments of the invention, lignin fibers and/or carbon fibers as described herein are incorporated into a composite material comprising a polymer. Exemplary polymers suitable for use in such a composite include, but are not limited to, epoxy, polyester, vinyl ester and nylon reinforced. Optionally, with fibers according to various exemplary embodiments of the invention contribute to strength of the composite. Optionally, this contribution is to a greater degree of strength than similar composites made with fibers from other sources.

Exemplary Incorporation of Lignin into Polymers

In some exemplary embodiments of the invention, lignin according to one or more embodiments described herein is compounded with a polymer. Polymers suitable for use in such compounding include, but are not limited to polypropylene (PP) and poly-acrylonitrile butadiene styrene (ABS) and nylon.

In some embodiments, the lignin compounded with the polymer at least partially spares a need for MgOH. Alternatively or additionally, in some embodiments, lignin serves as a charring agent in the compound and/or as a reinforcement agent and/or as a nucleation agent for the polymer. Use of lignin as a nucleation agent is expected to find utility, for example, in the injection molding industry as it contributes to ease of release of parts from a mold.

Exemplary Features of Products Produced from Lignin According to Exemplary Embodiments of the Invention

In those embodiments of the invention which relate to products produced from lignin, small but detectable amounts of marker molecules can serve to establish the source of the lignin from which the product was prepared. In this context “small but detectable amounts” indicates 1 PPB, 10 PPB or even 100 PPB. Marker molecules which establish a link to lignin according to an embodiment of the invention as an input material include, but are not limited to S1 solvents (e.g. hexanol and/or 2-ethyl-1-hexanol), chlorides derived from S1 solvents (e.g. hexyl chloride), covalently bound chorine, and a lignin polymer bound to an alcohol of at least 6 carbon atoms by an ether bond.

Exemplary Specific Gravity Considerations

Lignin according to various embodiments of the invention described herein has a specific gravity of about 1.3. This is relatively high compared to synthetic polymers (e.g. the specific gravity of polypropylene is about 0.9). However, many industrially acceptable fillers have a specific gravity much higher than that of lignin (e.g. calcium carbonated has a specific gravity of 2.5). Alternatively or additionally, flame retardants compounded with synthetic polymers are often characterized by a high specific gravity (e.g. MgOH has a specific gravity of 4). This means that in many embodiments of the invention, use of lignin in place of a conventional filler or flame retardant actually contributes to a reduction in specific gravity of a composition including a synthetic polymer.

Exemplary Environmental Impact Considerations

In some exemplary embodiments of the invention, lignin is used to replace a portion of the synthetic polymer when compounding a plastic. Many synthetic polymers are derived from petrochemicals, while lignin is typically derived from plant matter such as wood. Therefore, use of lignin according to various exemplary embodiments of the invention as a filler in plastics contributes to a reduction in carbon footprint of the resultant plastic, relative to a similar plastic compounded without lignin.

Exemplary Polymeric Compositions

Some exemplary embodiments of the invention relate to a composition including a synthetic polymeric material and a lignin composition as described herein. According to various exemplary embodiments of the invention, the synthetic polymeric material includes polypropylene (PP) and/or nylon and/or ABS (Acrylonitrile butadiene styrene).

In some embodiments, the lignin to synthetic polymer ratio is ≦0.67 on a weight basis. In some embodiments, the composition includes ≧10%, 12%, 14% or 16% lignin by weight. Alternatively or additionally, in some embodiments the composition includes ≦30%, 35% or 40% lignin by weight. Alternatively or additionally, in some embodiments, the composition has a transition temperature at least 3° C. higher than the transition temperature of the synthetic polymer as determined by ASTM D-3418 DSC. Optionally, the polymeric composition includes one or more non-lignin flame retardants such as, for example, magnesium hydroxide, melamine phosphate, pentaerythritol and triphenylphosphate

Exemplary Flame Retardant Compositions

In some exemplary embodiments of the invention, a polymeric composition as described above is formulated to meet the requirements of UL (Underwriters Laboratories) 94 V-2 for flame retardation.

For example, in some embodiments the polymeric composition includes at least 30% synthetic polymeric material; at least 5% flame retardant; and at least 10% lignin. In some embodiments, the polymeric composition includes at least 38% synthetic polymeric material; at least 10% flame retardant; and at least 14% lignin.

Alternatively or additionally, in some embodiments, a weight ratio of the flame retardant to the lignin in the composition is at least 1.5:1.0 or at least 2.0:1.0.

Alternatively or additionally, in some embodiments the amount of flame retardant in the composition is at least 10%, at least 15% or at least 20%.

Alternatively or additionally, in some embodiments which the amount of lignin in the composition is ≦50%, ≦40%, ≦30%, ≦20% or ≦10%.

Alternatively or additionally, in some embodiments, the amount of flame retardant in the composituion is ≦50%, ≦40%, ≦30%, ≦20% or ≦10%. Alternatively or additionally, in some embodiments the amount of lignin in the composition is at least 5%, at least 10%, at least 15% or at least 20%.

Exemplary Polymeric Composition Characteristics

In some exemplary embodiments of the invention, the polymeric compositions, which are optionally flame retardant compositions, exhibit one or more additional characteristics. These characteristics include, but are not limited to:

a rate of blooming which is at least 10% less than that of an identical composition formulated with Kraft lignin instead of lignin according to an exemplary embodiment of the invention;

a rate of UV degradation which is at least 10% less than that of an identical composition formulated with Kraft lignin instead of lignin according to an exemplary embodiment of the invention; and

a shelf life which is at least 10% less than that of an identical composition formulated with Kraft lignin instead of lignin according to an exemplary embodiment of the invention.

Alternatively or additionally, the polymeric compositions, which are optionally flame retardant compositions, have a specific gravity ≦1.06, optionally ≦1.0, optionally, ≦0.95.

Exemplary Manufacturing Process

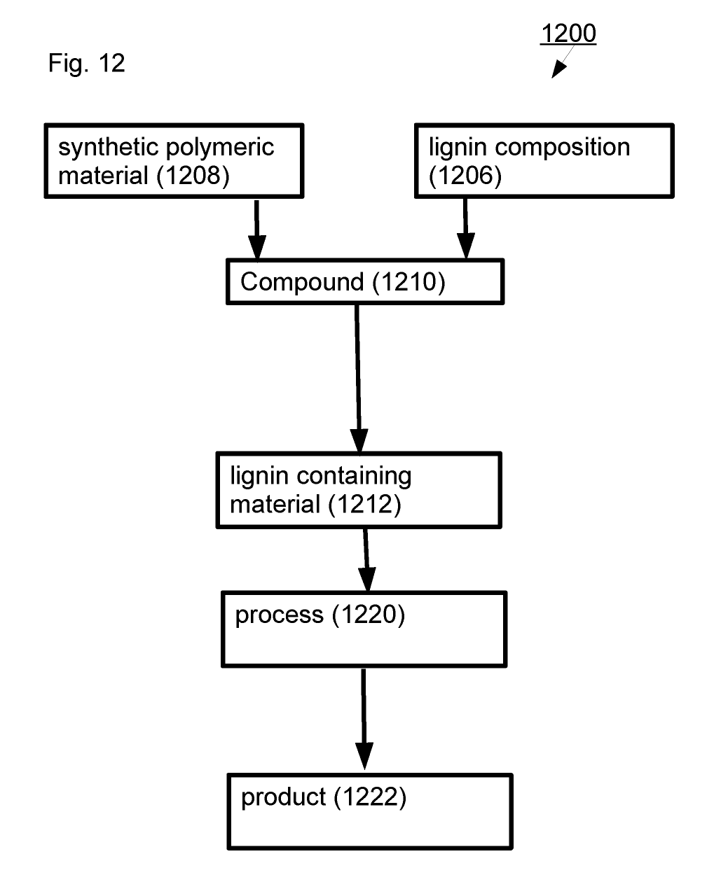

FIG. 12 is a simplified flow diagram of a manufacturing process according to some exemplary embodiments of the invention indicated generally as 1200. Depicted exemplary method 1200 includes compounding 1210 a synthetic polymeric material 1208 with a lignin composition 1206 as described herein to produce a lignin containing material 1212 and processing 1220 lignin containing material 1212 to produce a product 1222. Each product 1222 is an exemplary embodiment of the invention. According to various exemplary embodiments of the invention, processing 1220 produces a product 1220 such as, for example, construction materials, furniture, in-mold labeled products, co-injected products, co-extruded products, electronics housings, imitation wood panels, rugs and floor coverings. Alternatively or additionally, in some exemplary embodiments of the invention, compounding 1210 includes addition of plasticizers and/or flame retardants and/or dyes. According to these embodiments, the added materials are present in lignin containing material 1212. Alternatively or additionally, in some embodiments, compounding 1210 is conducted at a temperature ≧200° C.

In some exemplary embodiments of the invention, processing 1220 includes placing lignin containing material 1212 into a mold and removing lignin containing material 1212 from the mold. According to some of these embodiments, an elapsed time between the placing and the removing is shorter than in an identical molding process conducted on the same synthetic polymeric material 1208 without lignin. In some embodiments, lignin composition 1206 contributes to a reduction in solidification and/or crystallization temperature. According to various exemplary embodiments of the invention, the actual time reduction will vary according to the magnitude of change in crystallization temp and/or properties of the mold and/or properties of product 1222 being molded.

### Exemplary Oxidized Lignin Compositions

In some exemplary embodiments of the lignin composition described herein, lignin in the composition has a dry basis content of carboxylic functions greater than 0.05%, greater than 0.075% or even greater than 0.1%. According to various exemplary embodiments of the invention the composition includes solid, fibers or a suspension of solid in a main solvent. In general, an increase in carboxylic functions indicates an increased degree of oxidation of the lignin. In some exemplary embodiments of the invention, an increased degree of oxidation contributes to an improvement in interaction with synthetic polymeric materials 1208 during compounding 1208. Optionally, this improvement in interaction contributes to a reduction in blooming in product 1222. According to various exemplary embodiments of the invention a dry basis content of carboxylic functions in lignin of lignin composition 1206 is achieved by contacting the composition with a suitable oxidizing reagent.

Some exemplary embodiments of the invention relate to a lignin composition characterized (on a dry matter basis) by: (a) an ash content of less than 0.5%; and (b) a sulfur content of less than 0.07%. In some embodiments, this composition has a dry basis content of carboxylic functions greater than 0.05%.

### Exemplary High Purity Lignin Compositions

Some exemplary embodiments of the invention, relate to a lignin composition including less than 10%, 7%, 5%, 3%, 2% or even less than 1% non-lignin material.

In some embodiments, such a composition has an ash content of ≦1%, ≦0.5%, ≦0.1% or even ≦0.025%.

Alternatively or additionally, in some embodiments, such a composition has a total carbohydrate content of ≦1%, ≦0.5%, ≦0.05%, ≦0.05%, ≦0.025% or even ≦0.01%.

Alternatively or additionally, in some embodiments, such a composition has a non melting particulate content (>1 micron diameter) of ≦1%, ≦0.5%, ≦0.1%, ≦0.5%, ≦0.1% or even ≦0.05%. Particles smaller than 1 micron diameter are not considered when calculating the percentage. As used here the phrase “non melting” indicates particles which do not melt at 150° C. In some exemplary embodiments of the invention, the particles do not melt at 150° C., 175° C., 200° C., 225° C. or even 250° C. or intermediate or greater temperatures

Alternatively or additionally, in some embodiments, such a composition has a volatiles content of ≦5%, ≦4%, ≦3%, ≦2%, or ≦1% (at 200° C.).

Alternatively or additionally, in some embodiments the composition includes a chloride (Cl) content of less than 1%; less than 0.5%; or even less than 0.1%.

Alternatively or additionally, in some embodiments the composition includes a sulfur content of less than 0.07%; less than 0.05% or even less than 0.025%.

Alternatively or additionally, in some embodiments the composition includes a sulfur content of less than 70 PPM; less than 50 PPM or even less than 25 PPM.

Alternatively or additionally, in some embodiments the composition includes a phosphorus content of less than 100 PPM; less than 50 PPM or even less than 25 PPM.

Alternatively or additionally, in some embodiments the composition includes a soluble carbohydrate content of less than 5%; less than 2.5% or even less than 1%.

This type of composition is amenable to a wide variety of uses including, but not limited to, production of lignin fibers and/or carbon fibers.

Exemplary Options

Referring again to FIG. 1: in some cases, substrate 112 is chipped wood. During the chipping process, some fine fragments are formed which are far smaller than the target chip size. In some embodiments, substrate 112 is sorted into chips and fine fragments (e.g. by sieving). The chips are loaded into vessel 110 and used to produce lignin 220. In some embodiments, the fine fragments (fines) are incorporated into the process. According to various exemplary embodiments of the invention, the fines are combined with lignin 220.

In some exemplary embodiments of the invention, maintaining the ratio of fines:total substrate 112 below a certain threshold (e.g. ≦10%) contributes to a reduction in efficiency of contact between substrate 112 and acid 140 in reactor 110. This reduction in efficiency manifests as an increase in residence time. Increased residence time can contribute in turn to increased capital costs and/or higher levels of degradation products in hydrolyzate 130. Using the fines as described here contributes to a reduction in magnitude of the reduction in efficiency of contact caused by the fines with all that entails.

Alternatively or additionally, in some embodiments substrate 112 is pre-extracted with an organic solvent (e.g. acetone) and/or a weak acid (e.g. sulfurous acid and/or acetic acid) to separate pitch and/or tall oils. Exemplary pre-treatments for substrate 112 which can separate pitch and/or tall oils are described in co-pending application PCT/US2011/064237; which is fully incorporated herein by reference.

According to various exemplary embodiments of the invention the pitch and/or tall oils are combined with lignin 220.

It is expected that during the life of this patent many hydrolytic processes for cellulose will be developed and the scope of the invention is intended to include all such new technologies a priori.

As used herein the term “about” refers to ±10%; ±5%; ±1%; ±0.5% or ±0.01%.

Although the invention has been described in conjunction with specific embodiments thereof, it is evident that many alternatives, modifications and variations will be apparent to those skilled in the art. Accordingly, it is intended to embrace all such alternatives, modifications and variations that fall within scope of the appended claims.

Specifically, a variety of numerical indicators have been utilized. It should be understood that these numerical indicators could vary even further based upon a variety of engineering principles, materials, intended use and designs incorporated into the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus or system and features used to describe an apparatus or system can be used to characterize a method.

Alternatively, or additionally, features used to describe an apparatus can be used to characterize a system and features used to describe system can be used to characterize an apparatus.

It should be further understood that the individual features described herein can be combined in all possible combinations and sub-combinations to produce additional embodiments of the invention. The examples given above are exemplary in nature and do not limit the scope of the invention which is defined solely by the following claims. Specifically, the invention has been described in the context of methods but might also be give rise to apparatus and/or systems with similar features.

Each recitation of an embodiment of the invention that includes a specific feature, part, component, module or process is an explicit statement that additional embodiments not including the recited feature, part, component, module or process exist.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

Additional objects, advantages, and novel features of various embodiments of the invention will become apparent to one ordinarily skilled in the art upon examination of the following examples, which are not intended to be limiting. Additionally, each of the various embodiments and aspects of the present invention as delineated herein and as claimed in the claims section below finds experimental support in the following examples.

### EXAMPLES

Reference is now made to the following examples, which together with the above descriptions; illustrate the invention in a non-limiting fashion.

The following materials and methods are used in performance of experiments described in examples herein:

Lignin:

Unless otherwise indicated, reference to “Residual Lignin” in these examples indicates material as received from a pilot scale operation using pinewood as a hydrolysis substrate and hydrolyzed substantially as described in U.S. 61/483,777 and treating the un-hydrolyzed lignin substantially as described in PCT/IL2011/000424. Each of these co-pending patent applications is fully incorporated herein by reference. This lignin includes about 25% unhydrolyzed cellulose on a dry matter basis.

In some cases, lignin was subject to additional treatment to remove residual cellulose:

“HCl Lignin” indicates lignin with substantially no cellulose as formed on nearly full hydrolysis of cellulose by HCl according to U.S. 61/483,777. For the purpose of the examples here, Residual Lignin was subjected to further hydrolysis in 42% HCl (1:10 lignin-to-acid) for 24 hours at 13° C., filtered, washed thoroughly with water, and oven dried at 100° C.;

“Klason Lignin” as used in these examples indicates Residual Lignin subjected to further hydrolysis in 72% H₂SO₄ for 1 h, diluted to 3% sulfuric acid with water and incubated at 121° C. for 1 h, filtered, washed thoroughly with water, and dried as for HCl lignin. It is important to note that, “Klason Lignin” refers to lignin formed by hydrolyzing the vast majority of the cellulose by HCl, followed by hydrolyzing the rest by sulfuric acid. It is believed that this lignin is markedly different from “Standard Klason Lignin” where the majority or all the cellulose is hydrolyzed with sulfuric acid.

“Enzyme Treated Lignin” indicates Residual Lignin that was washed with water and dried in the oven at 105° C. overnight. For incubation 10 volumes of water were added to a weighed sample and the pH adjusted to 4.8 using 0.1N NaOH. One sample was taken as control and included only water and dry lignin (adjusted to pH 4.8 as well). Three enzymes were added to the tube containing the actual enzyme treated sample: Accelerase Duet, Accelerase Bg and Spirizyme Fuel HS. Spirizyme fuel: 67 mg enzyme to 1 g (100%) sugar, Accelerase duet: 80 mg/1 g sugar, Accelerase Bg: 80 mg/1 g sugar. The tubes were placed in the shaker at 60° C., 200 rpm for 3 days. Then a sample was taken from the aqueous phase, the solid was filtered and washed with water, then placed in the oven to dry overnight.

“Kraft lignin” was purchased from Sigma Aldrich (St. Louis Mo., USA) and served as a control.

Size Fractionation:

1360.2 g of dried lignin was partially sieved on “Vibratory sieve shaker AS 200 digit” (Retsch Inc.; Newtown, Pa., USA) with mesh sizes as indicated in Table 1. Every portion of lignin was separated under amplitude of 50 and for 5 min. Each fraction was weighed and distribution was evaluated according the following sieves dimensions.

TABLE 1
Mesh sizes for size fractionation of lignin:

| Mesh No | Aperture (μm) |
|---|---|
| 8 | 2360 |
| 30 | 600 |
| 40 | 425 |
| 80 | 180 |
| 140 | 106 |
| 200 | 75 |

### ICP and Ash Analysis:

Samples of lignin were digested in acid solutions (hydrochloric and nitric acids) at 95° C. for approximately 1 h and analyzed by Perkin Elmer (Waltham Mass., USA) model 4300DV ICP-OES instrument according to EPA 6010B metals in water and waste water procedures. Additional standards at different concentrations were spiked in sample and blank.

### CP/MAS ¹³C NMR—

¹³C spectra were acquired on Bruker Avance III 500 MHz spectrometer (Bruker BioSpin Corp., Billerica, Mass., USA) using a 4 mm VTN CPMAS HX probe, using MAS at 8 kHz. Cross-polarization (CP) experiments were carried out using a typical ramped pulse on the protons and a square pulse on ¹³C. The CP contact time was 1.4 milliseconds.

### TGA/DTG—

Thermo gravimetric analysis (TGA) and differential thermal analysis (DTA) of lignin were performed using a simultaneous thermal analyzer Q50 (TA Instruments, USA). The sample was heated from 30 to 950° C. at a rate of 10° C./min with a N₂ flow of 55 ml/min.

### DSC—

DSC measurements were carried out on DSC Q100 (TA Instruments, USA) over the 30-550° C. temperature range, at a heating rate of 10° C./min with N₂ flow of 50 ml/min.

### Electron Microscopy—

Scanning electron micrographs (SEM) of structure and surface were carried out on different samples of lignin <200 mesh. The powder samples were mounted on specimen stubs and coated with gold under vacuum of 100 miliTorr at RT. All photographs were taken at 3 to 5 kV accelerating voltage by using a field emission scanning electron microscope, FEI Inspect S (Oregon, USA).

### Elemental Analysis & Density—

Bulk density was performed according to ASTM-B527-93(2000) which is standard test for determination of Tap density. The Elemental analysis of carbon, nitrogen, hydrogen and sulfur content of organic material is determined by the FLASH EA 111 CHNS Analyzer. Samples were incinerated under 900° C. using He and O₂ atmosphere with flow rates of 140 ml/min and 250 ml/min respectively.

### Solubility—

Approximately 5 g of the sieved lignin (8<mesh<30) was blended with 120-150 g of various solvents according to the Table below. A high shear mixer, Silverson L4RT (Silverson, USA) equipped with square hole high shear screen and round emulsion screen was adjusted to 6000 rpm speed. The mixtures were stirred for 1 to 2 hours (see below) at RT and filtered under reduced pressure. The wet lignin was washed with ethanol and was evaporated to dryness. In order to identify small phenols, the solution was filtered through 0.22 μm and tested on HPLC-UV (λ=280 nm).

TABLE 2
Lignin solubility measurement parameters

| Sample | Lignin | | Solvent | Mixing |
|---|---|---|---|---|
| No | weight (g) | Solvent Type | weight (g) | time (min) |
| 1 | 5 | DMF | 144 | 105 |
| 2 | 5 | 2-(2-ethoxyethoxy) | 150.4 | 60 |
| | | ethylacetate | | |
| 3 | 5.1 | DMSO | 150.4 | 105 |

### Example 1

### Particle Size Distribution

In order to determine the particle size distribution, Residual Lignin was sieved as described above.

Particle size distribution is summarized in Table 3.

TABLE 3
Lignin particle size distribution

| size (μm) | % of total weight |
|---|---|
| >2360 | 0.1 |
| 600-2360 | 38.16 |
| 425-600 | 17.64 |
| 180-425 | 27.47 |
| 106-180 | 7.05 |
| 75-106 | 2.37 |
| <75 | 7.67 |

### Example 2

### ICP and Ash Analysis

Residual Lignin was incinerated and the remaining ash fraction (ash content) was 0.38% on a dry matter basis.

Inductively coupled plasma (ICP) analysis indicated the presence of specific minerals in quantities as summarized in Table 4.

TABLE 4
Quantitative mineral content in Lignin

| Element | (mg/kg) dry matter |
|---|---|
| Al | 139.7 |
| Ca | 1233.7 |
| Fe | 176 |
| K | 44.2 |
| Mg | 112.4 |
| Na | 202 |
| S | 279 |
| Si | 91 |
| Zn | 53 |
| P | <1.0 |

### Example 3

### Elemental Analysis and Density

Quantities of carbon and hydrogen in lignin according to exemplary embodiments of the invention were measured and oxygen amount was calculated by difference. Results are summarized in Table 5.

TABLE 5a
Elemental analysis of lignin

| | Elements | Residual Lignin | HCl Lignin |
|---|---|---|---|
| Elemental | C (%) | 57.5 | 63.2 |
| Analysis | H (%) | 6.32 | 6.09 |
| | O (%) | 36.08 | 29.89 |
| Formula | | C₉H_{11.78}O_{4.24} | C₉H_{10.42}O_{3.2} |
| Total Chlorine | Cl (%) | 0.46 | 0.93 |

Results presented in Table 5a indicate a relatively low O to C ratio in the assayed lignin. Since the Residual Lignin includes roughly 25% cellulose, HCl lignin has an even lower ratio.

Table 5b summarizes C/O ratios in lignin samples according to various exemplary embodiments of the invention with different amounts of residual cellulose as well as lignin from other sources. Results summarized in Table 5b suggest that lignin described herein is characterized by a lower C/O ratio than previously available Kraft Lignin or Sulfite Lignin. Once cellulose is removed (see HCl lignin), the C:O ratio is reduced even further. It is believed that Klason lignin and enzymatically treated lignin will have relative oxygen levels similar to that of HCl lignin.

TABLE 5b
Lignin Formula in samples from various sources

| Sample | Formula | Type |
|---|---|---|
| Residual lignin | C₉H_{11.78}O_{4.24} | embodiment |
| (approximately | | |
| 25% cellulose) | | |
| Lignin | C₉H_{11.25}O_{3.68} | By calculation* |
| (approximately | | |
| 18.75% cellulose) | | |
| Lignin | C₉H_{10.72}O_{3.11} | By calculation |
| (approximately | | |
| 12.5% cellulose) | | |
| Lignin | C₉H_{10.18}O_{2.55} | By calculation |
| (approximately | | |
| 6.25% cellulose) | | |
| HCl lignin | C₉H_{9.65}O_{1.98} | Calculated based upon |
| (presumed | | Residual lignin value |
| cellulose free) | | |
| Kraft lignin | C₉H_{7.63}O_{6.63} | Basis for comparison |
| Organosolv | C₉H_{8.64}O_{2.84} | Basis for comparison |
| lignin | | |
| Sulfite lignin | C₉H_{11.83}O_{7.56} | Basis for comparison |

*Using residual lignin with 25% cellulose as a base and a calculated value for HCl lignin presumed cellulose free. Cellulose is presumed to have a formula of (C₆H₁₀O₅)ₙ for purposes of calculation.

Results of density and bulk density measurements of Residual Lignin are summarized in Table 6. Results summarized in Table 6 suggest a relatively high degree of porosity and/or inter-particulate spacing.

TABLE 6
Density measurements of lignin

| | | Lignin |
|---|---|---|
| Bulk density | Primary density | 0.42 |
| (g/ml) | Final density | 0.52 |
| | Average density | 0.47 |
| Density (g/ml) | | 1.28 |

### Example 4

### CP/MAS ¹³C NMR Analysis

Residual Lignin was assayed by NMR to determine how it differs from pine wood and/or cellulose.

The results indicate that the assayed lignin contains both crystalline and amorphous forms of cellulose. The observed peaks resemble those observed in a similar analysis of pine wood on a qualitative basis. Analysis of fractions containing various particle sizes (see Table 3) produced similar results.

Similar NMR assays conducted on Klason lignin, HCl lignin and enzyme treated lignin indicated a significant decrease in the amount of cellulose associated with the lignin. These results are consistent with molecular formula analyses presented in Table 5b.

Some exemplary embodiments of the invention relate to an isolated lignin or lignin-containing composition with lignin containing less than 10% cellulose.

### Example 5

### TGA & DTG Analysis

Amorphous polymers such as lignin undergo a transition from a “glassy” state to a “rubbery” state at some temperature. This temperature is referred to as a glass transition temperature (Tg) and is often used to characterize a polymer.

The thermogravimetric behavior of isolated lignin samples is often difficult to determine. This difficulty is attributed to the source of lignin, heterogeneity of the chemistry within the lignin molecule (functional groups) and broad Mw distributions. In some cases, interrupting inter- and intramolecular hydrogen bonding by chemical derivatization of hydroxyl groups within the lignin (e.g. by esterification or alkylation) can reduce the heterogeneity of the polymer molecule population and make the Tg more easily discernible. Often, this is accompanied by an increase in the solubility of the lignin and its ability to undergo melt flow.

In a conventional TGA curve for lignin, weight loss starts around 190° C. and continues to 600° C. However cellulose has narrow weight loss between 330 to 380° C. due to its crystalline structure. Therefore, cellulose in a lignin sample can cause an inflection point of the main degradation step, which appears as a peak in the first derivative (DTG) curve.

TABLE 7
DTG inflection peak temperature for various samples

| Sample | Temperature ° C. |
|---|---|
| Cellulose | 360 |
| Lignin <200mesh | 348 |
| HCL lignin | 350 |
| Klason lignin | 393 |
| Enzyme lignin | 358 |
| Kraft lignin* | 355 |

*Sigma

Assayed lignin samples according to various exemplary embodiments of the invention (Residual; HCl; Klason; Enyzme) show a broad DTG curve with shoulder around 430° C.

### Example 6

### Additional TGA & DTG Analysis

TGA weight loss of lignin occurs in two stages: in the first stage there is water evaporation/dehydration and in the second stage thermal degradation takes place and divides to sub-steps.

Table 8 summarizes the onset of thermal degradation temperatures (Tᵢ), the temperature corresponding to maximum weight loss (Tₘₐₓ), mass loss (residual mass) of every decomposition sub-step (Δw_{d}) at a certain temperature, residual mass at ˜600° C. and total mass loss. All temperatures are in ° C.

TABLE 8
Thermal degradation of lignin

| | | | | | | Residual | Total |
|---|---|---|---|---|---|---|---|
| | | | | | | mass (%) at | mass loss |
| Sample | Tᵢ | Tₘₐₓ | Δw_{d} (%)-I | Δw_{d} (%)-II | Δw_{d} (%)-III | ~600° C. | (%) |
| Cellulose | 334.7 | 360 | 90@360 | — | — | 10@400° C. | 90 |
| Lignin <200 | 280 | 348 | 37.96@348 | 20.8@430 | 10.99@585 | 30.25 | 69.75 |
| HCL Lignin | 245.5 | 350 | 21.83@350 | 13.4@422 | 15.45@580 | 49.32 | 50.68 |
| Klason | 188.5 | 393 | 25.35@393 | 9.5@430 | 16.43@600 | 48.73 | 51.27 |
| Lignin | | | | | | | |
| Enzyme | 268 | 358 | 25.26@358 | 16.87@429 | 13.96@598 | 43.81 | 56.19 |
| Lignin | | | | | | | |
| Sigma Kraft | 263 | 355 | 24.46@355 | — | — | 48.63 | 51.37 |
| Lignin | | | | | | | |

Results summarized in Table 8 indicate that about 20% of carbohydrate polymers remained in “Residual Lignin”. This is consistent with data from solid state NMR and HPLC assays which indicated 21 and 26% residual cellulose respectively.

The lignin<200 mesh size fraction, Klason lignin, HCl lignin and Enzymatic lignin each show a broad DTG curve with shoulder around 430° C., while pure cellulose shows a sharp peak at 360° C. Most of the assayed lignin samples decompose at 350° C.

### Example 7

### Differential Scanning Calorimetry

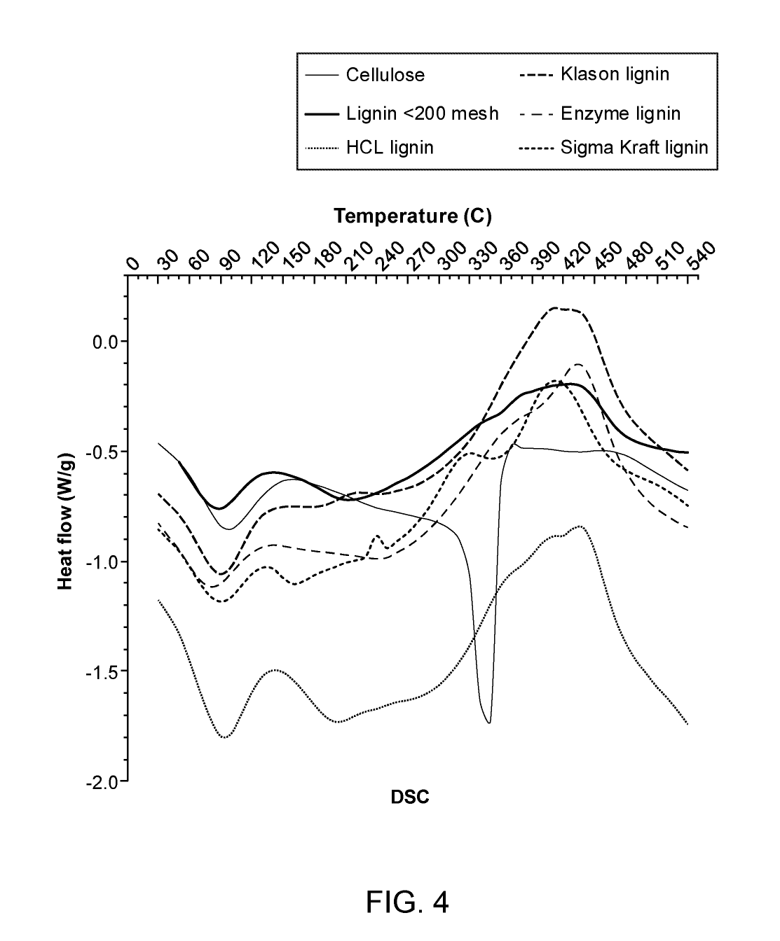

DSC patterns of Lignin samples according to various exemplary embodiments of the invention are shown in FIG. 4. The endotherms extended from about 100 to 250° C., are followed by an exotherm around 430° C. Similar data for cellulose and Kraft Lignin is provided for comparison.

The first endothermic reaction occurred around 100° C. and is believed to indicate the evaporation/dehydration of the absorbed water and the desorption of gases.

The second low and broad endotherm situated between 130 and 250° C. may represent cleavage of thermally unstable α- and β-aryl-alkyl-ether. Alternatively or additionally, this shallow and relatively flat portion of the curve may be related to the softening point of lignin but not to its melting point due to the absence of sharp endothermic peak as could be seen on cellulose thermograph.

After this decomposition, smaller non-volatilized molecules apparently re-combine to form char, causing the exothermic reaction between 280 and 450° C.

The peak around 430° C. may be related to condensation of aromatic rings resulting in formation of char.

The carbon in the char could be further condensed to graphite like rings. These results suggest that in some embodiments lignin does not melt but decomposes and then condenses.

The second endotherm situated between 130 and 250° C. could be considered as a softening point of lignin.

Kraft lignin contains 3 transition points realized as 3 exotherms while lignin according to various exemplary embodiments of the invention contains only one exotherm.

### Example 8

### SEM Analysis

FIG. 2 shows that HCl Lignin (panels g, h, i and j) is characterized by a woody structure with tunnels or tubules. This structure is observed also in the Residual Lignin of <200 mesh size fraction (panels a, b and c), in the Klason lignin (panels d, e and f), and the enzymatically treated lignin (panels k, l and m).

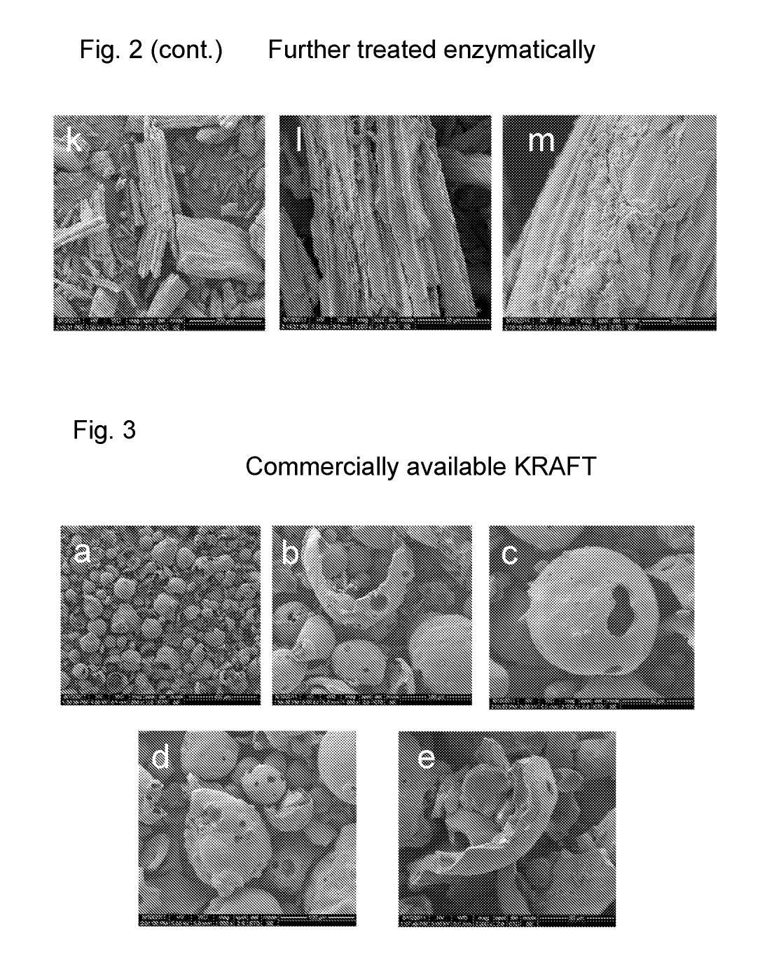

In sharp contrast, Kraft lignin (FIG. 3 panels a, b, c, d and e) exhibits a globular morphology.

This observed difference could be explained by proposed mechanism from polymeric science. Polymers are believed to tend to reduce their surface energy and assume structures possessing low surface energy.

During the isolation process of Kraft lignin the molecules may try to decrease their surface energy and arrange spontaneously in the observed globular structure. It is noted that sample preparation for SEM was identical for lignin according to various exemplary embodiments of the invention and Kraft lignin.

### Example 9

### Solubility

Solubility of HCl lignin in various organic solvents was assayed as described above. Results are summarized in Table 9.

TABLE 9
Solubility of lignin in various organic solvents

| Solvent | Percent solubility | Phenols in Ethanol |
|---|---|---|
| DMF | 14% | 1.45% |
| 2-(2-ethoxyethoxy) ethylacetate | 4% | 0.69% |
| DMSO | 17.7% | 0.04% |

Lignin according an exemplary embodiment of the invention has a low solubility, even in DMSO. A high shear mixer makes no apparent contribution to solubility. Sedimentation was observed to occur after mixing. In sharp contrast, Kraft lignin and organosolv lignin are completely soluble in DMSO.

Some exemplary embodiments of the invention, relate to lignin with a solubility of less than 20% in DMF and/or DMSO under the described conditions.

### Example 10

### Porosity Analysis Based Upon SEM Measurements

FIG. 5 is an enlarged version of the SEM of Residual Lignin in FIG. 2b. Representative measurements are superimposed on the figure.

The observed tubules or pores are characterized by a transverse cross-sectional dimension of about 5 to 20 μm with many having a transverse cross-sectional dimension of about 6 to 10 μm.

According to various exemplary embodiments of the invention, the aspect ratio of a transverse cross-sectional dimension to length of the observed tubules is less than 0.1, less than 0.05, less than 0.025, less than 0.02, or less than 0.01.

Similar structures are observed in HCl lignin, Klason Lignin and enzyme treated lignin, but not in Kraft lignin.

### Example 11

### Cl Content

Residual Lignin as described herein has a higher chloride (Cl) content than Kraft lignin. This is also true for HCl lignin, Klason Lignin and Enzymatically treated lignin produced from the Residual Lignin. The Cl in Kraft lignin is derived only from the wood. The Cl content of untreated pinewood is typically between about 0.001 and about 0.01% by weight. Assuming that all of this Cl ends up in Kraft lignin, there would be between about 0.003 and 0.03% Cl by weight, assuming 30% lignin. Since there is no evidence that all of the Cl remains in the lignin, actual values may be considerably lower for Kraft lignin.

Various exemplary embodiments of the invention relate to lignin comprising greater than 0.03%, 0.09%, 0.3%, 0.09%, 0.3%, 0.5% or 0.9%, Cl or to compositions containing such lignin.

### Example 12

### Solubility in NaOH

Samples of HCl lignin according to an exemplary embodiment of the invention and Kraft lignin were incubated in 5% NaOH for 3 hours at 75° C.

Kraft lignin was 81% soluble under these conditions while the HCl lignin was 9% soluble. Solubility was determined using by weight difference.

Various exemplary embodiments of the invention relate to lignin which is less than 50% soluble, less than 40% soluble, less than 30% soluble, less than 20% soluble, less than 10% soluble, or about 9% soluble in 5% NaOH under the described conditions.

### Example 13

### Olfactory Qualities

About 2 to 3 g of each of Kraft Lignin and HCl Lignin were evenly distributed on separate Petri dishes (I.D. 5 cm). Both sets of lignin were covered with water and heated to 90° C. Kraft Lignin and HCl Lignin each presented a distinctive aroma profile after two to three minutes.

HCl Lignin according to an exemplary embodiment of the invention had an ethereal, vanillic, slightly spicy, and clove-like aroma. In sharp contrast, the Kraft lignin had a moldy, smoky, and pungent aroma with burned notes.

### Example 14

### Proof of Principle for Spinning of Lignin

In order to demonstrate that HCl lignin compositions have the potential to serve as starting materials for industrial fiber spinning applications, the following experiment was conducted:

HCl Lignin (400 g) was heated in 10 liters of water with 300 g NaOH at 170° C. for 6 hours. The resultant lignin solution was dialyzed using a dialysis tube with 1 kDa cut-off. The dialyzed solution containing the retained lignin was then concentrated to 4% dissolved solids using a rotary evaporator.

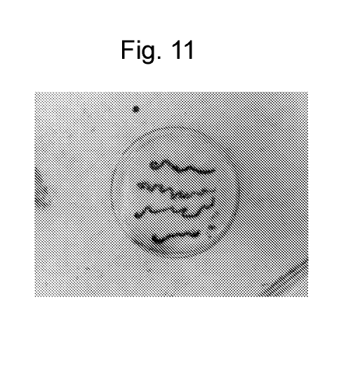

This concentrated solution was then loaded into a syringe and injected into a solution of ethanol and acetic acid. The acidified ethanol mixture served as an anti-solvent which caused the lignin to return to the solid phase as depicted in FIG. 11.

These results demonstrate that liquid lignin compositions according to exemplary embodiments of the invention can serve as input material for industrial spinning processes (e.g. wet spinning).

Some exemplary embodiments of the invention relate to conversion of lignin from a dissolved state to a solid state by contacting the dissolved lignin with an aliphatic alcohol (e.g. a pentanols, a butanol, a propanol, ethanol or methanol) and/or a weak acid (e.g. carbonic acid and/or acetic acid).

### Example 15

### Effect of Additional Hydrolysis on Elemental Composition of Lignin

In order to demonstrate the influence of HCl hydrolysis on lignin 220 (FIG. 1), elemental analyses were conducted using the following protocol:

Percentages of carbon, nitrogen, hydrogen and sulfur in the samples were determined by a FLASH EA 1112 CHNS Analyzer (CE Instruments). An EA 1110 (CE Instruments) analyzer was used for oxygen analysis. Samples were incinerated under 900° C. using He and O₂ atmosphere with flow rates of 140 ml/min and 250 ml/min respectively for CHNS determination and He atmosphere with flow rate of 140 ml/min for O determination.

Elemental analyses were conducted on two HCl Lignin samples derived from them (additional hydrolysis: Yes). Results are summarized in table 10. Values for commercially available Kraft lignin are provided for comparison. In this Example, values for O are by direct measurement and are believed to be more accurate than those presented in Example 3 (tables 5a and 5b). Calculation by difference in Example 3 and direct measurement as used in this Example accounts for the difference between elemental formula presented in Tables 5a and 10.

TABLE 10
Elemental analysis of lignin with and without additional HCl hydrolysis.

| additional | Kraft | Sample A | | Sample B | |
|---|---|---|---|---|---|
| hydrolysis | No | No | Yes | No | Yes |
| % C | 47.96 | 57.52 | 63.4 | 54.2 | 63.86 |
| % H | 4.93 | 6.34 | 5.57 | 5.79 | 5.45 |
| % N | 0.1 | — | 0.12 | 0.07 | 0.12 |
| % S | 1.56 | — | — | — | |
| % O | 25.57 | 26.47 | 21.55 | 29.35 | 20.73 |
| Total | 80.12 | 90.33 | 90.64 | 89.41 | 90.16 |
| Formula | C₉H_{11.02}O_{3.6} | C₉H_{11.82}O_{3.1} | C₉H_{9.42}O_{2.3} | C₉H_{11.45}O_{3.65} | C₉H_{9.22}O_{2.19} |

Results presented in table 10 indicate that acid hydrolysis using hydrochloric acid reduced the relative concentration of oxygen (O) and increased the relative amount of carbon (C) in the lignin material in the remaining lignin material. This improved profile is beneficial in the production of fuel products where reduced oxygen concentration is desired.

### Example 16

### Use of Lignin as a Filler

In order to investigate the feasibility of compounding HCl lignin according to an exemplary embodiment of the invention with synthetic polymeric materials, a series of plastics were prepared using polypropylene and varying amounts of lignin as a filler. Representative mechanical properties of the resulting plastics were tested as follows:

DMA storage modulus (ASTM D4065, Cantilever mode);

Flexural modulus test (ASTM D790), 3 point bending; and

Transition temperature (ASTM D-3418; characterized using DSC Q100 device of TA Instruments).

Compositions and their corresponding mechanical properties are presented in table 11. Values for 100% polypropylene (PP R-50) are provided for reference. Samples D, E and F include a commercially available flame retardant.

TABLE 11
Mechanical properties of plastics compounded with varying amounts of lignin.

| | | SAMPLE | | | | | | |
|---|---|---|---|---|---|---|---|---|
| Component | | PP | | | | D | | F |
| All values are % of total | | R-50 | | | | (control | | (control |
| weight | | control | A | B | C | for E) | E | for E) |
| PP R-50 | | 100 | 73.5 | 73.5 | 70 | 40 | 40 | 36 |
| Melapur MP | | — | 21 | — | 10 | — | — | — |
| PER | | — | 5.5 | — | — | — | — | — |
| Lignin | | — | — | 26.5 | 10 | — | 15 | — |
| Reofos TPP | | — | — | — | 10 | — | — | — |
| MDH* 120 DS-10 | | — | — | — | — | 60 | 45 | — |
| MDH* 100 DS-10 | | — | — | — | — | — | — | 60 |
| Polybond 3035 | | — | — | — | — | — | — | 4 |
| Mechanical property | | | | | | | | |
| | Temperature, | | | | | | | |
| | ° C. | | | | | | | |
| DMA | 0 | 2897 | 3242 | 3097 | 2247 | 5481 | 4908 | 5369 |
| Storage | 25 | 1771 | 2112 | 2136 | 1379 | 3632 | 3431 | 4052 |
| Modulus, | 50 | 1169 | 1548 | 1545 | 951 | 2441 | 2421 | 3221 |
| MPa | 70 | 769 | 1142 | 1092 | 654 | 1545 | 1664 | 2642 |
| | 90 | 546 | 841 | 820 | 461 | 1060 | 1207 | 2099 |
| | 100 | 459 | 720 | 711 | 384 | 877 | 1025 | 1859 |

| | | | | | | | |
|---|---|---|---|---|---|---|---|
| Flexural Modulus, MPa | 1628 | 2244 | 2017 | 1366 | 4065 | 3725 | 6215 |
| DSC, Tc, ° C. | 109.5 | | 116.5 | 114.2 | 113.4 | 115.9 | |

*Commercial MgOH based flame retardant (Dead Sea Bromine Compounds; Israel)

Results summarized in table 11 indicate that:

Composition B with 26.5% HCl lignin by weight demonstrated improved hardness and thermal stability, expressed as DMA storage modulus and flexural modulus, relative to PP R-50.

Fire retardant composition E in which 15% HCl lignin replaced a similar amount of MDH demonstrated enhanced thermal stability at elevated temperatures (DMA data) compared with control flame retardant composition D.

Each of compositions B, C and E demonstrated increased crystallization temperatures (DSC data). This increase in crystallization temperature is important in an industrial context because it contributes to a reduction in cooling time. Reduced cooling times in injection molding and/or extrusion processes contribute to an increase in overall operational; efficiency and/or output.

These results suggest that lignin according to exemplary embodiments of the invention can be compounded with a wide range of synthetic polymeric materials (e.g. polypropylene; ABS; PAN and nylon). Alternatively or additionally, these results suggest that such compounding contributes to an increase in DMA storage modulus and/or an increase in flexural modulus, and/or an increase in DSC transition temperature.

### Example 17

### Use of Lignin in Flame Retardant Compositions

In order to investigate the feasibility of using lignin HCl lignin in flame retardant materials a series of flame retardant plastics were prepared using polypropylene and varying amounts of lignin filler in conjunction with a conventional flame retardant.

A composition including 40% polypropylene (PP R-50), 45% Magnesium hydroxide (MDH 120 DS10) and 15% HCl lignin meets the criteria of UL 94 V-2 for flame retardation (Sample E in the previous example). This formulation exhibited satisfactory performance in compression molding.

Results presented in this example and the previous example indicate that lignin can be used as a filler in plastics, even flame retardant plastics.

### Example 18

### Use of Lignin in Acrylonitrile Butadiene Styrene (ABS) Based Compositions

In order to evaluate the feasability of compounding lignin HCl lignin in acrylonitrile butadiene styrene (ABS) polymer based compositions a series of ten additional compositions was prepared under normal compounding conditions. Some of the compositions included commercially available phosphate based flame retardants (Reofos TPP and/or Reofos RDP; Polymate; People's Republic of China). In addition the compositions included a stabilizer (Irganox 1076; BASF Schweiz AG (formerly Ciba specialty Chemicals); Basel; Switzerland).

Compositions 6 and 10 without flame retardant served as negative controls in UL 94 assays of flame retardation. The compositions and their performance in UL 94 flame retardation assay and compression molding at elevated temperatures are summarized in Table 12.

TABLE 12
Exemplary acrylonitrile butadiene styrene (ABS) compositions and their performance

| | Composition | | | | | | | | | |
|---|---|---|---|---|---|---|---|---|---|---|
| | 1 | 2 | 3 | 4 | 5 | 6 | 7 | 8 | 9 | 10 |
| Component | | | | | | | | | | |
| All values are % of | | | | | | | | | | |
| total weight | | | | | | | | | | |
| ABS Polylac 757 | 84.5 | 79.5 | 74.5 | 74.5 | 69.5 | 74.5 | 69.5 | 69.5 | 59.5 | 95.5 |
| Irganox 1076 | 0.5 | 0.5 | 0.5 | 0.5 | 0.5 | 0.5 | 0.5 | 0.5 | 0.5 | 0.5 |
| Reofos TPP | 15 | 15 | 15 | 10 | 15 | — | 10 | 5 | — | — |
| Reofos RDP | — | — | — | — | — | — | 5 | 5 | 10 | — |
| Lignin | — | 5 | 10 | 20 | 15 | 25 | 15 | 20 | 30 | — |
| Properties | | | | | | | | | | |
| UL 94 V-2 | NO | YES | YES | NO | YES | NO | YES | NO | NO | NO |
| Compliant? | | | | | | | | | | |
| Compression | bubble | bubble | bubble | bubble | bubble | bubble | bubble | bubble | bubble | bubble |
| molding: 180° C. | free | free | free | free | free | free | free | free | free | free |
| Compression | bubble | bubble | bubble | bubble | bubble | bubble | bubble | bubble | bubble | bubble |
| molding: 200° C. | free | free | free | free | free | free | free | free | free | free |

Compositions 2, 3, 5 and 7 were determined to comply with UL 94 V-2 flame retardation requirements. Composition 3 performed slightly better than compositions 2, 5 and 7.

All of the tested compositions exhibited satisfactory performance in compression molding at 180 and 200° C.

These results confirm that lignin can be incorporated into an ABS based composition as a filler at 5 to 30% without adversely affecting molding properties at relevant temperatures. In contrast to Example 16, the lignin was substituted for the synthetic polymer in this experiment (compare compositions 2 and 3 to 1).

The results also indicate that lignin can impart flame retardant qualities to a composition which would not be flame retardant without lignin (compare compositions 2 and 3 to composition 1).

These results are consistent with those of the previous two examples in suggesting that lignin can be used as a filler with a wide range of synthetic polymers, even if flame retardation requirements are a manufacturing constraint.

### Example 19

### Preservation of Woody Structure after Fine Milling

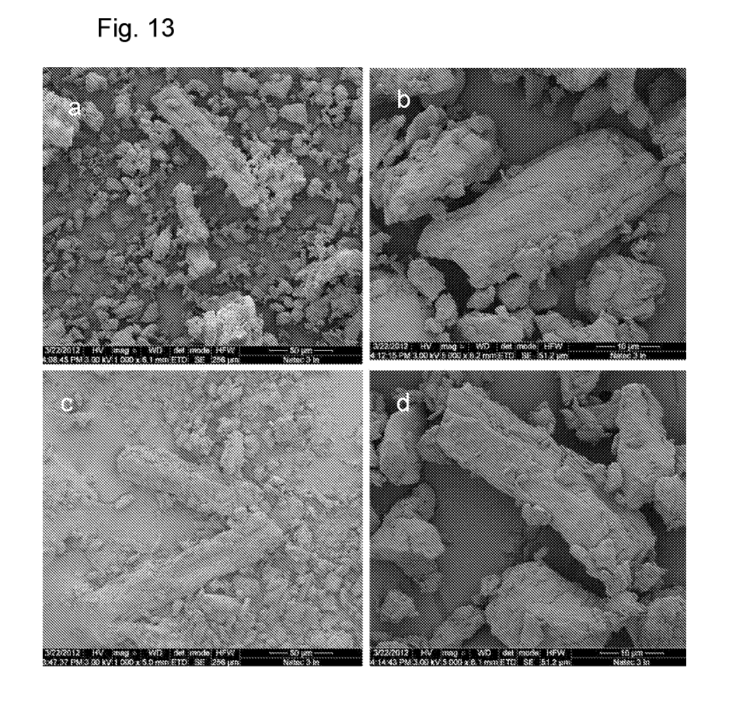

FIG. 13 is a series of scanning electron micrographs (SEM) of HCl lignin that was milled with a Retsch ball mill mixer to ≦50 μm size (90% of the sample ≦40 μm). These images show that the woody structure seen in FIGS. 2b and 5 is preserved even at very small particle sizes. In some exemplary embodiments of the invention, lignin particles with a greatest dimension less than 100 μm have a length:width aspect ratio of ≧1.5; ≧2.5; ≧3.5 or ≧5.0.

1-67. (canceled)

68. A lignin composition characterized (on a dry matter basis) by at least one, characteristic selected from the group consisting of:
(a) a formula of C₉H_{X}O_{Y}; wherein X is at least 9 and Y is less than 5;
(b) an O/C ratio of less than 0.34;
(c) an O/C ratio less than previously reported for lignin from a same specific lignocellulosic source;
(d) an H/C ratio of less than 2;
(e) an ash content of less than 0.5%;
(f) a sulfur content of less than 70 PPM %;
(g) a phosphorus content of less than 100 PPM;
(h) a soluble carbohydrate content of less than 5%;
(i) comprising less than 3% non-lignin material;
(j) a total carbohydrate content of less than 0.05%
(k) a non melting particulate content (>1 micron diameter; at 150° C.) of less than 0.05%; and
(l) a volatiles content of less than 5% at 200° C.;
wherein said composition is provided as a solid or as fibers.

69. The composition according to claim 68 characterized (on a dry matter basis) by at least three said characteristics.

70. The composition according to claim 68 characterized (on a dry matter basis) by at least five said characteristics.

71. The composition according to claim 68 characterized (on a dry matter basis) by at least nine said characteristics.

72. The composition according to claim 68, prepared from a substrate comprising hardwood, a substrate comprising softwood, or a substrate comprising hardwood and softwood.

73. A product comprising the lignin composition according to claim 68 and one or more other ingredients, wherein the product is a product selected from the group consisting of: carbon fibers, protective coatings, lignosulfonates, pharmaceuticals, dispersants, emulsifiers, complexants, flocculants, agglomerants, pelletizing additives, resins, adhesives, binders, absorbents, toxin binders, films, rubbers, elastomers, sequestrants, solid fuels, paints, dyes, plastics, wet spun fibers, melt spun fibers and flame retardants.

74. A spinning method comprising:
(a) providing the composition according to claim 68;
(b) softening lignin in said composition; and
(c) spinning and cooling said lignin to produce fibers.

75. The method according to claim 74, wherein said softening is conducted in the presence of plasticizers.

76. The method according to claim 74, comprising softening a synthetic polymeric material with said lignin.

77. The method according to claim 76, wherein said synthetic polymeric material comprises polyacrylonitrile (PAN).

78. The method according to claim 74, wherein a ratio of lignin:synthetic polymer is ≧1:10 or ≦10:1.

79. The method according to claim 74, wherein a ratio of lignin:synthetic polymer is between about 1:10 and about 10:1.

80. A fiber produced by the method according to claim 74.

81. A composite material comprising a polymer including one or more materials selected from the group consisting of epoxy, polyester, vinyl ester and nylon reinforced with fibers according to claim 80.

82. A method comprising:
providing an input material comprising the lignin composition according to claim 68; and
processing said input material to produce a processed product;
wherein said processed product includes one or more members selected from the group consisting of carbon fibers, activated carbon, activated carbon fibers, absorbent materials, coatings, phenol resins, adhesives, dispersants, flocculants, phenols, terphthalate, epoxies, Benzene/Toluene/Xylene (BTX), liquid fuels, polyols and polyolefins.

83. A composition comprising:
(a) synthetic polymeric material; and
(b) the lignin composition according to claim 68;
wherein the lignin to synthetic polymer ratio is ≦0.67.

84. The composition according to claim 83, having an ASTM D-3418 DSC transition temperature at least 3° C. higher than the transition temperature of the synthetic polymer, or meeting the requirements of UL (Underwriters Laboratories) 94 V-2 for flame retardation.

85. The composition according to claim 83, comprising:
at least 30% synthetic polymeric material;
at least 5% flame retardant; and
at least 10% lignin.

86. The composition according to claim 83, wherein said synthetic polymeric material includes one or more members of the group consisting of polypropylene, nylon and poly-acrylonitrile butadiene styrene (ABS).

87. The composition according to claim 86, further comprising at least one item selected from the group consisting of magnesium hydroxide, melamine phosphate, pentaerythritol and triphenylphosphate.
